(19) United States
(12) Patent Application Publication
(10) Pub. No.: US 2023/0074732 A1
(43) Pub. Date: Mar. 9, 2023

(54) Facial Recognition For Age Verification In Shopping Environments

(71) Applicant: Adroit Worldwide Media, Inc., Aliso Viejo, CA (US)

(72) Inventors: Kevin Howard, Aliso Viejo, CA (US); Kurtis Van Horn, Aliso Viejo, CA (US); Greg Schumacher, Aliso Viejo, CA (US); Matt Maslin, Aliso Viejo, CA (US); Cody Tanner, Aliso Viejo, CA (US); Mike Smith, Aliso Viejo, CA (US); Bill Leonhardt, Aliso Viejo, CA (US); Jeff Clarke, Aliso Viejo, CA (US); Steven Dabic, Aliso Viejo, CA (US); Richard Do, Aliso Viejo, CA (US)

(21) Appl. No.: 17/902,668

(22) Filed: Sep. 2, 2022

Related U.S. Application Data
(60) Provisional application No. 63/240,839, filed on Sep. 3, 2021.

(51) Int. Cl. G06Q 30/06; G06Q 30/02; G06V 40/16

(52) U.S. Cl. CPC G06Q 30/0607; G06Q 30/0281; G06V 40/172

(57) ABSTRACT

In frictionless shopping environments, there may be a variety of age-restricted products. Shopping areas within the frictionless shopping environment can include one or more smart shelving units that have various restricted areas to house these age-restricted products. These restricted areas can be locking cabinets or other method of preventing any customer from grabbing the products. The frictionless shopping environment can comprise customer tracking and matching to customer data within an enrollment server or other device that can include a verified age associated with a customer that can be utilized to provide access to one or more age restricted products. Verification can occur via scanning of identification cards which can be processed by image processing methods or via a human review. Once verified, the customer can be matched and tracked within a frictionless shopping area and provide automatic access to age-restricted products either by customer location, voice request, or time period.

### PRIORITY

This application claims the benefit of priority to U.S. Ser. No. 63/240,839, filed Sep. 3, 2022, the entirety of which is incorporated herein.

### FIELD

The field of the present disclosure generally relates to retail merchandising and purchasing systems. More particularly, the field of the invention relates to generating a facial recognition with age verification for customers to access restricted areas within a frictionless shopping environment.

### BACKGROUND

Consumers are increasingly pressed for time and are confronted with information about a continuously increasing number of products in retail environments. Traditionally, consumers/customers encounter several obstacles when shopping in-person in retail environments. For example, a customer generally faces obstacles during their shopping experience between entering and leaving a retail store. These obstacles typically include selecting products from a vast array of products, checking out with the selected products, and providing payment for the selected products. However, as retail stores become more streamlined, many consumers are increasingly favoring options that reduce the number of obstacles between the start and end of their shopping experiences. This has led to a growing number of customers turning to online shopping for their day-to-day shopping experiences and purchases.

In addition, customers often enter a retail store or location with a limited amount of time to purchase particular products, such as age restricted products. However, when customers want to purchase age restricted products at retail stores, the customers often encounter various inefficient and time-consuming obstacles in relation to the sale and purchase of the age restricted products. These inefficient and time-consuming obstacles include: (i) requiring the customers to always carry one or more forms of identification (ID) to demonstrate proof of age; (ii) requiring in-person reviews of the customers' IDs at checkout/payment areas of the stores with their cashier personnel, and (iii) requiring some customers to carry alternate forms of ID to further demonstrate proof of age and/or identify when their ID is worn out, expired, damaged, and so on. Therefore, there is an ongoing need for retailers to increase operational efficiencies, create intimate customer experiences, streamline processes, and provide real-time understanding of customer behavior in their stores.

### BRIEF DESCRIPTION OF THE DRAWINGS

The above, and other, aspects, features, and advantages of several embodiments of the present disclosure will be more apparent from the following description as presented in conjunction with the following several figures of the drawings. The drawings refer to embodiments of the present disclosure in which:

FIG. 1 provides an illustration of a frictionless shopping system network, in accordance with an embodiment of the present disclosure;

FIG. 2 provides an illustration of a frictionless shopping system within a store of FIG. 1, in accordance with an embodiment of the present disclosure;

FIG. 3 provides an illustration of an intelligent shelf system, in accordance with an embodiment of the present disclosure;

FIGS. 4A-4C are schematic illustrations of one or more sensors coupled one or more intelligent shelves, in accordance with some embodiments of the present disclosure;

FIG. 5 provides a first logical representation of a frictionless shopping system, in accordance with an embodiment of the present disclosure;

FIG. 6 provides a second logical representation of a frictionless shopping system, in accordance with an embodiment of the present disclosure;

FIG. 7 provides an illustration of an image captured by a camera of a frictionless shopping system, in accordance with an embodiment of the present disclosure;

FIG. 8A provides an illustration of a three-dimensional shopping area space generated by the frictionless shopping system, in accordance with an embodiment of the present disclosure;

FIG. 8B provides an illustration of an overhead two-dimensional shopping area space generated by the frictionless shopping system, in accordance with an embodiment of the present disclosure;

FIG. 8C provides an illustration of a series of images captured by a plurality of customer recognition cameras of the frictionless shopping system, in accordance with an embodiment of the present disclosure;

FIG. 9A provides an illustration of an image being processed with skeletal recognition techniques captured by a customer recognition camera of the frictionless shopping system, in accordance with an embodiment of the present disclosure;

FIG. 9B provides an illustration of multiple images being processed with customer recognition techniques captured by a customer recognition camera of the frictionless shopping system, in accordance with an embodiment of the present disclosure;

FIG. 10A provides an illustration of an image being processed with inventory recognition techniques captured by an inventory camera of the frictionless shopping system, in accordance with an embodiment of the present disclosure; and

FIG. 10B provides an illustration of multiple images being processed with inventory recognition techniques captured by an inventory camera of the frictionless shopping system, in accordance with an embodiment of the present disclosure.

### DETAILED DESCRIPTION

The embodiments described herein relate to systems and related methods for frictionless shopping which provides shopping experiences with reduced obstacles for customers in retail environments. As described in greater detail below, the embodiments particularly relate to systems and related methods for generating a facial recognition for an age verification of a customer in a frictionless environment, such as a facial recognition wallet or the like. The facial recognition wallet (hereinafter referred to as “facial wallet”) utilizes stored facial wallet data and provides the customer with the necessary proof of identification and age verification to purchase one or more age restricted products in the frictionless environment.

The approval to access and purchase age-restricted products within the frictionless shopping environment can be provided based on a predetermined period of time once verified and approved, access provided at a certain distance from the tracked customer, or upon selection of a particular number of age-restricted products. In many embodiments, this access is provided by allowing the matched and age verified customer to gain access to one or more restricted areas, such as a locked cabinet, within a smart shelving unit. The ability to quickly access, verify, and match customers within a shopping area of the frictionless shopping system can be facilitated through the use of a facial wallet that stores this data in a secure and/or quickly accessible location.

The facial wallet may also allow the customer to purchase an age restricted product for pickup at a store locker or cooler. This allows the embodiments to eliminate the obstacles faced with shopping experiences which necessitate an in-person review of one or more forms of identification to verify a customer is of legal age to purchase one or more age restricted products, including alcoholic beverages, tobacco products, and so on.

For example, a facial wallet for age verification may be generated by a frictionless shopping system network with a frictionless shopping system, one or more stores, and an enrollment system. In various embodiments, the frictionless shopping system network may implement the enrollment system to allow the user with one or more forms of valid identification (ID) to enroll remotely and/or in-person with a live person, such as an enrollment agent (or the like) who may assist the user remotely and/or in-person. This allows the agent to review the user's ID, verify the user's age from the ID, and capture one or more high resolution images of the user's ID, where, in some embodiments, this further allows the agent to detect any fake, expired, etc., user IDs using an automated ID authentication/detection system or the like.

For example, the generated facial wallet for the age verification of the customer can be based on at least one or more verification factors, including, but not limited to, (i) a first verification factor based on the date of birth from the ID verified by the enrollment agent, (ii) a second verification factor configured to automatically verify the date of birth from the ID of the customer by matching a face disposed on the ID with a face captured on a high resolution camera, and/or (iii) a third verification (or an additional stage of authentication) implemented with the automated ID detection system (e.g., an artificial intelligence-based (AI-based) detection system), which is configured to provide additional authentication measures for the age verification by validating the age of the customer based on the captured face of the customer.

Continuing with the above example, after the enrollment, when the user visits one of the stores, the frictionless shopping system may implement facial and voice matching recognition to identify the user in the store, and thereby generate the facial wallet for the age verification of the user based on the user's age verified through the enrollment system. This allows the embodiments described herein to enhance the frictionless shopping experience of the customer by reducing the obstacles between entering and leaving the store with one or more age restricted products, without needing an ID and an in-person review of the ID as the customer enters and leaves a checkout area of the store with the age restricted products.

Before some further embodiments are provided in greater detail, it should be understood that particular embodiments provided herein do not limit the scope of the concepts provided herein. It should also be understood that a particular embodiment provided herein may have features that may be readily separated from the particular embodiment and optionally combined with or substituted for features of any number of other embodiments provided herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise. Unless defined otherwise, all technical and scientific terms used herein have the same meaning as commonly understood by those of ordinary skill in the art.

Aspects of the present disclosure may be embodied as an apparatus, system, method, and/or computer program/application product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like. A component, as used herein, comprises a tangible, physical, non-transitory device. For example, a component may be implemented as a hardware logic circuit comprising custom circuits, gate arrays, or other integrated circuits; off-the-shelf semiconductors such as logic chips, transistors, or other discrete devices; and/or other mechanical or electrical devices.

A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In some embodiments, a circuit may include custom circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware or the like). A circuit may comprise one or more silicon integrated circuit devices (e.g., chips, die, die planes, packages, etc.) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

As used herein, reference to reading, writing, storing, buffering, processing, and/or transferring data may include the entirety of the data, a portion of the data, a set of the data, and/or a subset of the data. Likewise, reference to reading, writing, storing, buffering, processing, and/or transferring non-host data may include the entirety of the non-host data, a portion of the non-host data, a set of the non-host data, and/or a subset of the non-host data.

Further, aspects of the present disclosure are described below with reference to schematic flowchart diagrams and/or schematic block diagrams of methods, apparatuses, systems, and computer program/application products according to embodiments of the disclosure. It will be understood that each block of the schematic flowchart diagrams and/or schematic block diagrams, and combinations of blocks in the schematic flowchart diagrams and/or schematic block diagrams, may be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

Lastly, in the following detailed description, reference is made to the accompanying drawings. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

In general, the present disclosure described herein includes embodiments for frictionless shopping that provide frictionless shopping experiences with reduced obstacles for customers in retail environments. In particular, the present disclosure includes embodiments for frictionless shopping experiences with reduced obstacles for the customers between entering and leaving stores for the purchase of age restricted products. This may be implemented by providing a means of generating facial wallets with age verifications of the customers in frictionless environments, such as frictionless retail environments, stores, store lockers or coolers, and so on.

Additionally, the present disclosure also includes several other embodiments for frictionless shopping experiences with further reduced obstacles for the customers. This may be accomplished by providing a means of intelligently tracking inventory on, for example, intelligent retail shelves with capabilities that provide a means of determining the proximity of retail customers as they approach, and collect data related to the inventory and customers including their location, actions, identity, and overall engagement with the shopping experience.

In embodiments, the frictionless shopping system comprises of at least one intelligent shelving system which may include at least one or more of, but is not limited to, one or more cabinet top displays, fascia, cameras, sensors (e.g., vision-enabled sensors, proximity sensors, inventory sensors, demographic tracking sensors), and so on. The cabinet top display is configured to display animated and/or graphical content and is mounted on top of in-store shelves. The fascia includes one or more panels of light-emitting diodes (LEDs) configured to display animated/graphical content as well as electronic/digital shelf labels and to be mounted to an in-store retail shelf. The frictionless shopping system also includes a product presentation system that includes a media player configured to simultaneously execute a multiplicity of media files that are displayed on the cabinet top and the fascia. The cabinet top and the fascia are configured to display content so as to entice potential customers to approach the shelves, and then the fascia may switch to displaying pricing and other information pertaining to the merchandise on the shelves once a potential customer approaches the shelves.

The proximity sensor may be configured to detect the presence of potential customers. Further, one or more inventory sensors may be configured to track the inventory stocked on one or more in-store retail shelves. Also, one or more customer recognition cameras may be configured to identify and track customers within a given shopping area. The frictionless shopping system may also create one or more alerts once the stocked inventory remaining on the shelves is reduced to a predetermined minimum threshold quantity. All of the foregoing methods and features may be networked and expanded over additional intelligent shelving units and the processing of all the data may be either centralized or distributed across the one or more processors residing within the plurality of intelligent shelves and/or frictionless shopping devices.

Additionally, all the captured inventory and customer data is processed and analyzed to determine customer actions within the shopping area including whether a customer has selected a product from the shelf, determining what product was selected, adjusting inventory levels accordingly, and extract payment for the selected product based on one or more predetermined rules that indicate a purchase has been made by the customer. In certain embodiments, the purchase information is received and/or coordinated by a companion mobile shopping application running on a customer's personal computing device, a kiosk or terminal in the store, and/or the like. This may allow the customer to provide feedback as to what items are being purchased and also includes the payment information and authorization of the customer for the selected product.

In additional embodiments, the frictionless shopping system may provide the customer with a portable computing device that is specifically designed to aid in the tracking of the customer within the store and provides a means of inputting payment information and authorization. In further embodiments, a customer signs up for an account with the store including their personal data, payment information, and payment authorization. This may provide a method for a customer to enter a store, select items off of a shelf, and leave without interacting with a store employee or application on the personal computing device or the customer's mobile computing device. The frictionless shopping system in these instances may track the customer entering the store, gather data regarding the customer, identify the customer based on data stored in the customer's account with the store, determine what products were selected off of the shelf, and initiating a sale utilizing the customer payment info and authorization associated with their account upon initiation of a predetermined action by the customer indicating a sale should be processed. For example, the predetermined action may include entering a checkout area of the store with the products, leaving the store with the products, and/or any other similar actions.

In this way, the frictionless shopping systems allow for stores and other retailers to provide a means of selling products to consumers, customers, or the like that compete with methods of shopping that shoppers find in an online environment. Furthermore, the frictionless shopping system allows for reduced manpower needed to check out customers purchasing items, provides a way for inventory to be tracked at near-real time with up to per-item resolution, and/or creates engaging shopping experiences that may better engage customers that may otherwise not become aware of a given product or promotion. Moreover, this frictionless shopping system also allows for various advanced analytics of user (e.g., shopper) and employee behavior patterns. This also allows a store, who is operating in a hybrid mode (i.e., where there are some shoppers using such frictionless systems and other shoppers that are not using those systems), to help identify theft/reduction of products by providing a comparison of (i) what shoppers purchased (or took) with (ii) what ended up getting rung up at the traditional register or the like.

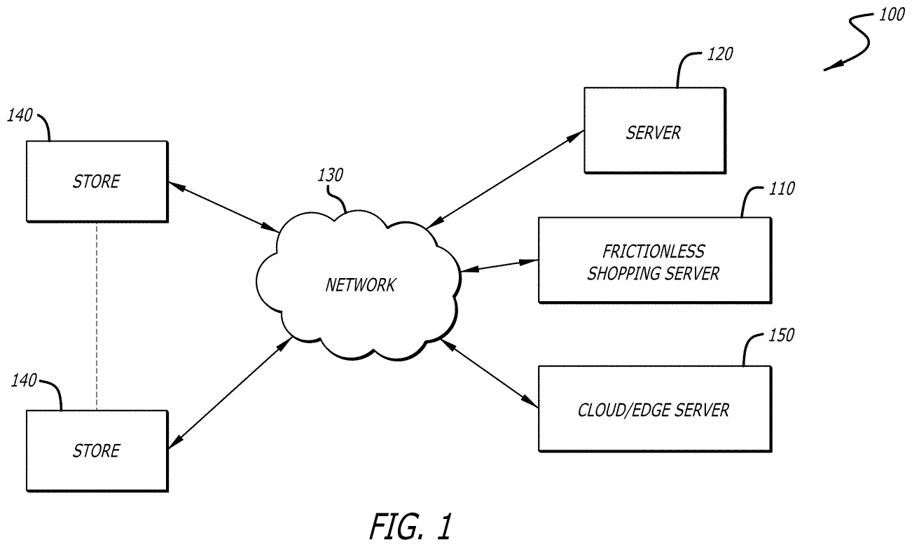

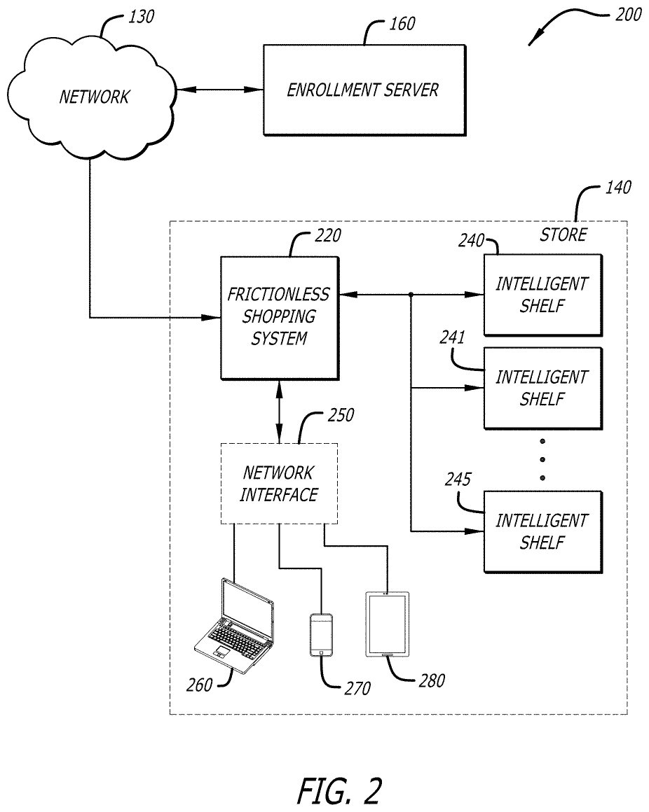

Referring now to FIG. 1, an illustration of a frictionless shopping system network 100 is shown, in accordance with embodiments of the present disclosure. The frictionless shopping system network 100 may comprise a frictionless shopping server 110, a server 120, a network 130, one or more stores 140, a cloud/edge server 150. In embodiments, one or more frictionless shopping systems may be implemented with the frictionless shopping system network 100. In the embodiments, a frictionless shopping system may be entirely contained within a store 140, for example, as depicted below with a frictionless shopping system 220 within the store 140 with regards to FIG. 2. In certain embodiments, the frictionless shopping system may be installed in multiple stores 140 and may have its operations be supplemented by facilitating a communication link between the multiple stores 140, where such stores 140 may also operate as essentially standalone stores (e.g., such as store coolers, store lockers, etc., in a hotel, pool premise, airport, etc.).

In further embodiments, the frictionless shopping system may utilize a network 130 such as the Internet to facilitate a remote connection to other devices that may supplement and/or aid the function of the frictionless shopping system. In certain embodiments, the frictionless shopping system may utilize the server 120 to provide data processing, storage, and/or retrieval required for the frictionless shopping system. In some embodiments, the server 120 may be utilized for a variety of purposes including, but not limited to, updating data within a store-located frictionless shopping system, providing updated inventory data, providing updated pricing data, receiving new promotional data, and/or providing new and updated customer data such as new/updated facial wallets with new/updated age verifications, new/updated expiration dates for the facial wallets, revoked facial wallets, and so on. It should be understood that the server 120 may be utilized by the frictionless shopping system to update or supplement any type of data, without limitation. Also, it should be understood the server 120 may be configured with PaaS cloud implementations and/or similar cloud computing implementations, without limitations.

In embodiments, the stores 140 may include a variety of consumer environments including, but not limited to, a retail store, a package store, a grocery store, a liquor store, a store locker/cooler, a convenient store, a pharmacy store, a supermarket store, a wholesale warehouse retailer, a hypermarket, a discount department store, and/or any other types of stores that sale goods and services including age restricted products. In other embodiments, the stores 140 may include a web-based store or the like depending on various factors including location, regulations, policies, etc. For example, the web-based store may sale a product such as an age-restricted product to: (i) a user online (e.g., via the Internet) and have the online-purchased product delivered or stocked in a store locker, cooler, etc., associated with the web-based store for the user to pick-up; (ii) a user in-person (e.g., in a store) and have the instore-purchased product delivered or stocked in a store locker, cooler, etc., associated with the web-based store for the user to pick-up; and/or a user or the like implementing other similar processes.

In the embodiments, the stores 140 may comprise one or more intelligent shelves but not any frictionless shopping systems. In some embodiments, a frictionless shopping server 110 may be utilized to add such functionality to a pre-existing system and/or installation. By way of a non-limiting example, the frictionless shopping server 110 may receive data from the intelligent shelves including, but not limited to, image data captured from the sensors/cameras on (or associated with) the intelligent shelves within the store 140 and transmit the data over the network 130 to the frictionless shopping server 110 for processing and inventory, customer, and probability data generation which may then be either further processed by the frictionless shopping server 110 or may be transmitted back to the store 140 for further processing. In this way, the frictionless shopping system may be marketed as a service that may be added on to stores 140 with existing hardware that may facilitate the frictionless shopping system.

In more embodiments, portions of the frictionless shopping system may be served by the use of a cloud/edge server 150 from a third party. It should be understood that the use of cloud/edge servers 150 and/or any other similar cloud computing devices/systems may allow for both increased data delivery and transmission speeds, as well as ease of scalability should the frictionless shopping system be implemented quickly over a large area or number of stores 140. In some embodiments, the cloud/edge server 150 may facilitate many aspects of the frictionless shopping system up to providing the entire frictionless shopping processing necessary for implementation. By way of a non-limiting example, the cloud/edge server 150 may be used to implement most, if not all, of the data stores necessary for the frictionless shopping system. In additional embodiments, the cloud/edge server 150 may provide or supplement image processing capabilities in conjunction with the image processing capabilities of the enrollment server 160, and/or may provide ground truth data with a variety of machine learning, predetermined rule sets, and/or deep convolutional neural networks.

In some embodiments, the enrollment server 160 may be configured to provide data processing, storage, and/or retrieval required for the frictionless shopping system and/or any other component of the frictionless shopping system network 100. In other embodiments, the enrollment server 160 may be configured to be implemented and utilized on users' mobile computing devices as an added option, service, and/or the like. The enrollment server 160 may be implemented to provide customer/consumer data used to generate facial wallets for age verifications of customers in the stores 140. In the embodiments, the customer data may be comprised of a plurality of data inputs related to one or more customers, including, but not limited to, name, address, date of birth, gender, height, weight, form of ID, ID number, ID expiration date, ID issue date, ID issuing state, high resolution images of both sides of the ID, customer facial image and data, in-depth 2D/3D recognition data associated with the customer's facial data, customer voice recording, payment information, contact information, customer password or pin number, expiration date and age verification for the facial wallet, and/or any other desired customer data input, which may be acquired during an in-person enrollment review session with a live person as described below.

In embodiments, the frictionless shopping system network 100 may be implemented to generate a facial wallet with an age verification of a customer in one of the stores 140. In the embodiments, the frictionless shopping system network 100 may configure the enrollment system 160 to provide remote and/or in-person authentication processes, such as, but not limited to, enrollment review sessions with one or more live persons (who may assist users remotely and/or in-person) and one or more image recognition processing devices, which can be used to facilitate face and voice matching recognition capabilities of the frictionless shopping system.

In some embodiments authentication processes may further include the enrollment server 160 being configured to allow customers with one or more forms of valid ID to enroll in-person in an in-person enrollment review session with a live person to validate their identification and record their age to verify that it exceeds one or more predetermined age thresholds. The live person may review the customer's ID, verify the customer's age from the ID, capture high resolution images of the customer's ID, and/or any other desired customer data input that may be necessary to provide the age verification of the customer for the facial wallet. In more embodiments, one or more image recognition processes may be utilized to perform an authentication process or assist in formatting data prior an in-person review such as to verify no alterations have been made to the ID.

Finally, when the customer visits any of the stores 140 (e.g., retail stores, coolers, lockers, etc.), the frictionless shopping system may implement facial and/or voice matching recognition to identify the customer in one of the stores 140. In some embodiments, in response to accurately identifying the customer in the store 140, the frictionless shopping system may be configured to communicate with the enrollment server 160 via the network 130 to determine: (i) whether the identified customer is enrolled in the enrollment server 160; (ii) if the customer is enrolled, whether the identified customer has the age verification necessary to purchase an age restricted product that includes a predetermined age threshold; and (iii) if the customer has the necessary age verification, whether the age verification is still valid based on one or more predetermined rules and not expired based on a predetermined time period.

After the proper determinations are established via the enrollment server 160, the frictionless shopping system may then generate the facial wallet with the age verification for the customer to use while shopping in the store 140. In the embodiments, the generated facial wallet with the age verification allows the customer to pick up an age restricted product in the store 140 and leave the store 140 with the age restricted product, without needing to provide an ID for the age restricted product before leaving the store 140, needing an in-person review of the ID at a checkout area of the store 140, and/or needing to provide payment information for the age restricted product when the customer leaves the store 140. For example, the age restricted product may include, but is not limited to, an alcoholic beverage, a liquor, a spirit, a tobacco product, theft-susceptible products, pharmaceutical products, and/or any other similar age restricted product and/or service such as a lottery ticket or the like.

Referring now to FIG. 2, an illustration of a frictionless shopping system network 200 is shown, in accordance with embodiments of the present disclosure. The frictionless shopping system network 200 may be comprised of a network 130, an enrollment server 160, and a store 140 with a frictionless shopping system 220. As discussed above, the frictionless shopping system 220 may be deployed within a store 140 to create a frictionless shopping experience. The frictionless shopping system network 200 may include the frictionless shopping system 220 communicatively coupled with the network 130 and/or the enrollment server 160, which may be used to provide data including, but not limited to, inventory updates, customer data updates, system updates, ground truth data, promotional data updates, and/or facial wallet data and updates. The frictionless shopping system network 200 in FIG. 2 may be similar to the frictionless shopping system network 100 depicted in FIG. 1. Likewise, the network 130 and enrollment server 160 in FIG. 2 may be substantially similar to the network 130 and enrollment server 160 depicted in FIG. 1. Additionally, the frictionless shopping system 220 may also utilize the network 130 to transmit data with the server 120 and/or cloud/edge server 150 depicted in FIG. 1. In certain embodiments, the data externally communicated may include, but is not limited to, inventory data, customer data, engagement data, proximity data, facial wallet data, and/or data related to image processing.

In many embodiments, the frictionless shopping system 200 is communicatively coupled to a plurality of intelligent shelves 240, 241, 245. Although only three intelligent shelves 240, 241, 245 are depicted in FIG. 2, it should be understood that any stores 140 may employ any number of intelligent shelves 240, 241, 245 as desired/necessary for the given application, without limitation. In certain embodiments, the frictionless shopping system 220 may be housed solely within one or more of the intelligent shelves 240, 241, 245. In other embodiments, the frictionless shopping system 220 may be realized by networking one or more of the intelligent shelves 240, 241, 245 together with the representative components to create a single frictionless shopping system such as the frictionless shopping system 220. Meanwhile, in some embodiments, each of the intelligent shelves 240, 241, 245 may house and be configured to implement a single frictionless shopping system.

In some embodiments, the frictionless shopping system network 200 may include a network interface 250 which may allow the frictionless shopping system 220 to communicate with any type of computing devices capable of being used by a consumer/customer. For example, the computing devices may include, but are not limited to, portable computers 260, smartphones 270, portable computing tablets 280, and so on. In other embodiments, the computing devices may also include, but are not limited to, a personal computer (PC), a laptop computer, a mobile device, a tablet computer, a smart watch, a wearable computing device, a fitness tracker, a personal digital assistant device (PDA), a global positioning system (GPS) device, a handheld communications device, a vehicle computer system, an embedded system controller, a portable remote control, a consumer electronic device, any combination thereof, any other similar computing device, and/or any type of sensors such as a radio frequency identification device (RFID) or the like.

In various embodiments, the frictionless shopping system 220 may be configured to push out notifications and/or queries to the computing devices 260, 270, 280 to supplement the frictionless shopping experience. Such notifications and/or queries may include, but are not limited to, sale notifications, selection confirmation queries, payment confirmation queries, device identification information requests, facial wallet with age verification notifications, and/or so on. Conversely, the communicative connection between the frictionless shopping system 220 and the computing devices 260, 270, 280 via the network interface 250 may also facilitate the receiving of data from the mobile computer devices 260, 270, 280 into the frictionless shopping system 220. Although one network interface 250 is depicted within the store 140 in FIG. 2, it should be understood that the network interface 250 may be implemented separate from the store 140 without limitation. Also, although one network interface 250 is depicted to transmit data between the frictionless shopping system 220 and the computing devices 260, 270, 280 in FIG. 2, it should be understood that the frictionless shopping system 220 may be configured to transmit data with any of the computing devices 260, 270, 280 via any type of networks 130 and/or any other communication interfaces, without limitation.

By way of a non-limiting example, a customer may use the smartphone 270 with a store loyalty application or the like, which may be configured to notify the frictionless shopping system 220 of the presence of the customer within the store 140. For example, the smartphone 270 may be configured to send a notification to the network interface 250, the network 130, and/or the frictionless shopping system 220 that the customer is in the store 140 and/or scheduled to visit the store 140. This notification may prompt the frictionless shopping system 220 to start searching for the customer, and to employ face and voice matching recognition to detect/identify the customer in the store 140, when the customer is approaching the store 140, and/or the like. In additional embodiments, any of the computing devices 260, 270, 280 may also transmit data related to customer location within the store, data related to desired items for purchase, data related to shopping history for promotional data selection and display based on such history, and/or payment related data. For example, the data related to the desired items for purchase may include shopping list data or the like, which may include any type of age restricted products. It should be understood that all data tracking, sharing, and gathering processes may be facilitated in a manner that is compliant with all local, state, federal, and/or international laws/regulations.

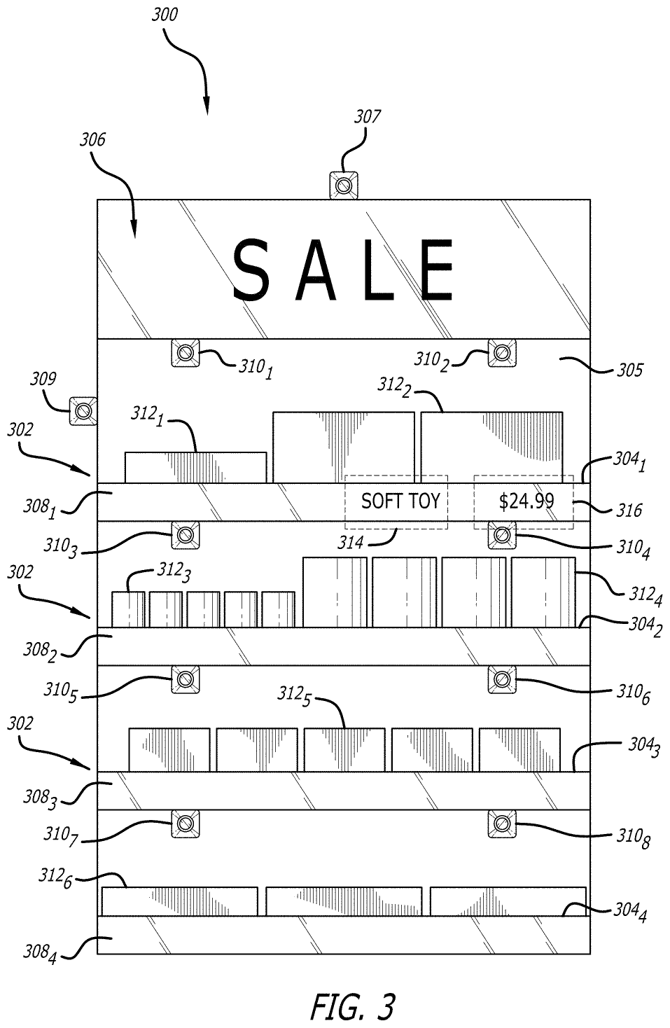

Referring now to FIG. 3, an illustration of an intelligent shelf 300 is shown, in accordance with embodiments of the present disclosure. The intelligent shelf 300 depicted in FIG. 3 may be substantially similar to the intelligent shelves 240, 241, 245 depicted in FIG. 2. Additionally, the frictionless shopping system 220 depicted in FIG. 2 may be configured to operate the intelligent shelf 300 depicted in FIG. 3 similar to the intelligent shelves 240, 241, 245 depicted in FIG. 2. In embodiments, the intelligent shelf 300 may comprise a proximity sensor 307, a plurality of fascia 308₁-308₄, a customer recognition camera 309 (e.g., a facial recognition camera, an anonymous demographic detection and recognition camera, etc.), and a plurality of inventory cameras 310₁-310₁, where i≥1 and i=8 for some non-limiting embodiments. That is, although one sensor 307, four fascia 308₁-308₄, one customer recognition camera 309, and eight inventory cameras 310₁-310₈ are depicted in FIG. 3, it should be understood that any number of sensors 307, fascia 308₁-308₄, customer recognition cameras 309, and eight inventory cameras 310₁-310₈ may be used with the intelligent shelf 300, without limitations. For example, in some embodiments, the intelligent shelf 300 may be implemented with one or more weight sensor platforms, pusher sensors, and/or the like, which may be used to receive one or more additional user/product/store-based data points.

It is noted that the embodiments are not limited to the intelligent shelf 300 including a single cabinet display top 306 but may include a plurality of cabinet top displays 306. Additionally, the intelligent shelf 300 is not limited to the number of fascia, shelving units, proximity sensors, customer recognition cameras and/or inventory cameras shown in FIG. 3. In embodiments, the intelligent shelf 300 couples to a shelving unit 302, which includes shelves 304, a back component 305, and a cabinet top display 306. For example, the back component 305 may be a pegboard, a grid wall, a slat wall, etc.

In some embodiments, the cabinet display top 306 is coupled to an upper portion of the shelving unit 302, extending vertically from the back component 305. Further, a proximity sensor 307 may be positioned on top of, or otherwise affixed to, the cabinet top display 306. Although one proximity sensor 307 is depicted in FIG. 3 as being centrally positioned atop the cabinet top display 306, it should be understood that any number of proximity sensors 307 may be used by the intelligent shelf 300, and that the one or more proximity sensors 307 may be positioned in various different locations, such as near either end of the top of the cabinet top 306, on a side of the cabinet top 306 and/or at other locations coupled to the shelving unit 302 and/or the fascia 308, without limitation.

In the embodiments, any of the cameras 309, 310₁-310₈ and/or sensors 307 may be comprised of any type of imaging and/or audio devices with facial and/or voice processing capabilities, which may include, but are limited to, light- and/or sound-based cameras and/or sensors such as digital cameras, microphones, combinations thereof, and so on. It should be understood that any of the sensors and/or cameras may employ depth tracking technology to create depth maps that may be utilized by any of the components presented within the frictionless shopping system, without limitation. Also, it should be understood that any of the cameras and/or sensors, including any of the cameras 309, 310₁-310₈ and sensors 307, may be used for facial and voice matching recognition processing by the intelligent shelf 300, without limitation.

Furthermore, at least one or more of the sensors 307 and cameras 309, 310₁-310ᵢ may be implemented to capture audio signals and/or may include a microphone or the like, which may be coupled with the shelving unit 302 and arranged into an advantageous microphone geometry for capturing the voice of the customer. In some embodiments, the voice recognition may be implemented when a customer is proximate to the foregoing sensor/camera on the shelving unit 302 and speaks a training phrase, a voice password, and/or the like that is captured and processed by such sensor/camera on the shelving unit 302. In the embodiments, upon the voice recognition of the customer, a voice verification may be implemented to verify that the spoken training phrase, voice password, and/or the like, strongly match with the customer's voice. In other embodiments, the voice recognition may be implemented to capture any type of voices and/or spoken word(s) of the customer, which may be used to verify the customer via an external verification server such as an enrollment server similar to the enrollment server 160 depicted in FIG. 1-2. That is, when the customer enrolled with the enrollment server, the enrollment server may be implemented to collect images of the customer's ID in conjunction with stored audio samples of the customer's voice, which may be used to (i) identify and authenticate the customer, and/or (ii) reestablish the customer's identity if the customer leaves the tracked area and re-enters for reasons including, but not limited to, using a restroom within the store.

Additionally, it should be understood that various types of recognition and/or authentication processes may be implemented by the intelligent shelf 300, without limitation. For example, the intelligent shelf 300 may pair the authentication of the voice recognition of the customer with the authentication of the facial recognition of the customer, where, in such example, the combination of facial recognition and voice recognition of the intelligent shelf 300 may be comprised of a two-stage authentication. Furthermore, in some embodiments, those authentication processes of the intelligent shelf 300 may also be configured to cooperate with an anti-spoofing detection system in order to help prevent user spoofing (e.g., prevent a user from holding up a photo), where the anti-spoofing detection system may include, but is not limited to, infrared imagery, depth information, multi-frame liveness detection, and so on. However, it should be understood that the facial and voice matching recognition may be implemented as a one-stage authentication, a two-stage authentication, and so on, without limitation. For example, in some embodiments, each of the facial recognition and the voice recognition may include one or more layers of authentication based on the desired application or the like, without limitation.

The cabinet display top 306 and fascia 308 may be attached to the shelves 304 by way of any fastening means deemed suitable, wherein examples include, but are not limited or restricted to, magnets, adhesives, brackets, hardware fasteners, and the like. The fascia 308 and the cabinet display top 306 may each be comprised of one or more arrays of light emitting diodes (LEDs) that are configured to display visual content (e.g., still or animated content), with optional speakers, not shown, coupled thereto to provide audio content. Any of the fascia 308 and/or the cabinet display top 306 may be comprised of relatively smaller LED arrays that may be coupled together so as to tessellate the cabinet display top 306 and the fascia 308, such that the fascia and cabinet top desirably extend along the length of the shelves 304. The smaller LED arrays may be comprised of any number of LED pixels, which may be organized into any arrangement to conveniently extend the cabinet display top 306 and the fascia 308 along the length of a plurality of shelves 304. In some embodiments, for example, a first dimension of the smaller LED arrays may be comprised of about 332 or more pixels. In other embodiments, a second dimension of the smaller LED arrays may be comprised of about 62 or more pixels. However, it should be understood that the smaller LED arrays may be comprised of any number of pixels, without limitation.

The cabinet display top 306 and the fascia 308 may be configured to display visual content to attract the attention of potential customers. As shown in FIG. 3, the cabinet display top 306 may display desired visual content that extends along the length of the shelves 304. The desired content may be comprised of a single animated or graphical image that fills the entirety of the cabinet display top 306, or the desired content may be a group of smaller, multiple animated or graphical images that cover the area of the cabinet display top 306. In the embodiments, the fascia 308 may cooperate with the cabinet display top 306 to display either a single image or multiple images that appear to be spread across the height and/or length of the shelves 304.

In the embodiments, the cabinet display top 306 may display visual content selected to attract the attention of potential customers to one or more products comprising inventory 312, e.g., merchandise, located on the shelves 304. As such, the visual content shown on the cabinet display top 306 may be specifically configured to draw the potential customers to approach the shelves 304 and is often related to the specific inventory 312 located on the corresponding shelves 304. A similar configuration with respect to visual content displayed on the fascia 308 may apply as well, as will be discussed below. The content shown on the cabinet display top 306, as well as the fascia 308, may be dynamically changed to engage and inform customers of ongoing sales, promotions, and advertising. As will be appreciated, these features offer brands and retailers a way to increase sales locally by offering customers a personalized campaign that may be easily changed quickly, by selling ad space to third parties to generate ad revenue, and so on.

Moreover, as described above, portions of the fascia 308 may display visual content such as images of brand names and/or symbols representing products stocked on the shelves 304 nearest to each portion of the fascia. For example, in some embodiments, a single fascia 308 may be comprised of a first portion 314 and a second portion 314. The first portion 314 may display an image of a brand name of inventory 312 that is stocked on the shelf above the first portion 314 (e.g., in some embodiments, stocked directly above the first portion 314), while the second portion 316 may display pricing information for the inventory 312. Additional portions may include an image of a second brand name and/or varied pricing information when such portions correspond to inventory different than inventory 312. It should be understood, therefore, that the fascia 308 extending along each of the shelves 304 may be sectionalized to display images corresponding to each of the products stocked on the shelves 304, without limitation. It should be further understood that the displayed images will advantageously (i) simplify customers quickly locating desired products, (ii) streamline restocking activities for employees and other third parties, and (iii) provide indicators to facilitate a click-and-collect signal, a pick-to-light signal, etc., for order fulfillment activities.

In embodiments, the animated and/or graphical images displayed on the cabinet display top 306 and the fascia 308 are comprised of media files that are executed by way of a suitable media player. The media player preferably is configured to simultaneously play any desired number of media files that may be displayed on the smaller LED arrays. In the embodiments, each of the smaller LED arrays may display one media file being executed by the multiplayer, such that a group of adjacent smaller LED arrays combine to display the desired images to the customer. Still, in some embodiments, base video may be stretched to fit any of various sizes of the smaller LED arrays, and/or the cabinet display top 306 and fascia 308. It should be appreciated, therefore, that the multiplayer disclosed herein may enable implementing a single media player per aisle in-store instead of relying on multiple media players dedicated to each aisle, and may utilize a proprietary video codec/player and/or the like in order to optimally play a high quantity of small video files in a performant way and in sync with each other, without limitations.

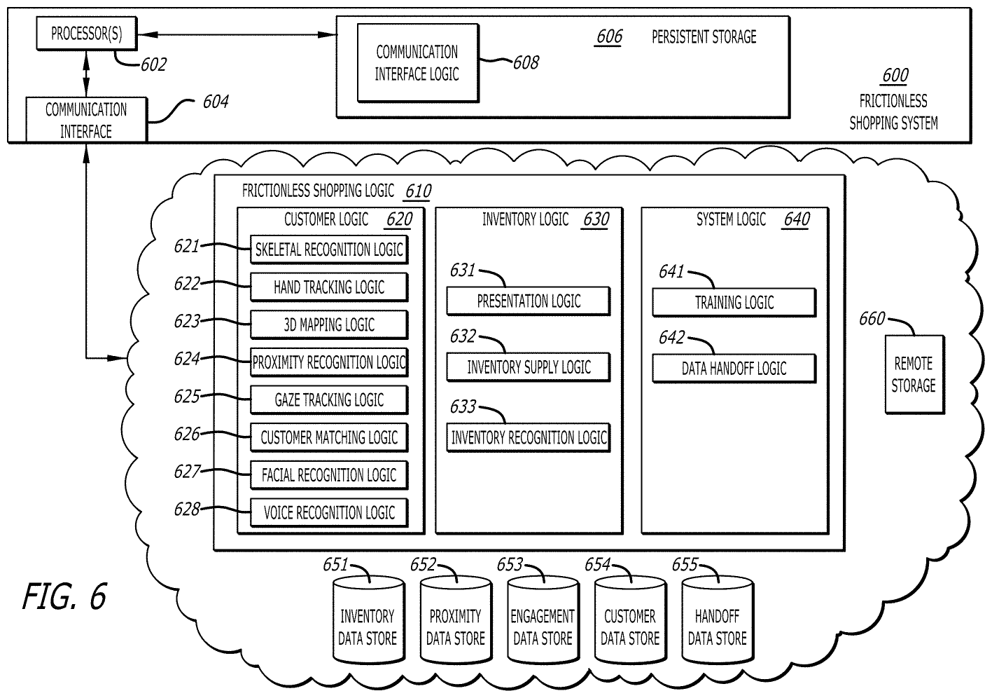

In the embodiments, the inventory cameras 310₁-310₈ may be coupled to the shelving unit 302, e.g., via the pegboard 305, and positioned above merchandise 312, which may also be referred to herein as “inventory.” Each of the inventory cameras 310₁-310₈ is configured to monitor a portion of the inventory stocked on each shelf 304, and in some embodiments, may be positioned below a shelf 304, e.g., as is seen with the inventory cameras 310₃-310₈. However, in some embodiments, an inventory camera 310 may not be positioned below a shelf 304, e.g., as is seen with the inventory cameras 310₁-310₂. Taking the inventory camera 310₄, as an example, the inventory camera 310₄ is positioned above the inventory portion 316 and therefore capable of (and configured to), monitor the inventory portion 316. Although, it should be noted that the inventory camera 310₄ may have a viewing angle of 180° (degrees) and is capable of monitoring a larger portion of the inventory 312 on the shelf 304₂ than merely inventory portion 316. For example, FIG. 7 illustrates one exemplary image captured by an inventory camera having a viewing angle of 180°.

It should be understood that the positioning of any of the inventory cameras 310₁-310₈ may differ from the illustration of FIG. 3. In addition to being positioned differently with respect to spacing above inventory 312 on a particular shelf 304, the inventory cameras 310₁-310₈ degree may be affixed to the shelving unit 302 in a variety of manners, which such being upon the type of shelves 304 as well as the type of inventory 312.

In addition to the proximity sensor 307 and the inventory cameras 310₁-310₈, the intelligent shelf 300 may include a customer recognition camera 309. In some embodiments, the customer recognition camera 309 may be coupled to the exterior of the shelving unit 302. In the embodiments, the customer recognition camera 309 may positioned five to six feet from the ground in order to obtain a clear image of the faces of a majority of customers. In further embodiments, the intelligent shelf 300 may comprise multiple customer recognition cameras 309, which may be placed in a variety of different locations to better capture customer recognition data such as, but not limited to, spatial location, facial data, voice data if any of the cameras 309 are configured to detect and record customer voice, and/or so on.

The customer recognition camera 309 may be positioned at heights other than five to six feet from the ground. Although the one customer recognition camera 309 depicted in FIG. 3 is coupled to exterior of the shelving unit 302, it should be understood that any customer recognition cameras 309 may be positioned and coupled to any of the shelving units in any desired locations, without limitation. For example, the customer recognition camera 309 may be coupled to in the interior of a side of the shelving unit 309 as well as to any portions of any of the shelves 304₁-304₄, the cabinet display top 306, the fascia 308 and/or the back component 305 of the shelving unit 302. Additionally, in some embodiments, a plurality of customer recognition cameras 309 may be coupled to the shelving unit 302.

In the embodiments, the intelligent shelf 300 may include one or more processors, a non-transitory computer-readable memory, one or more communication interfaces, and logic stored on the non-transitory computer-readable memory. The images or other data captured by any of the proximity sensors 307, the customer recognition cameras 309 and/or the inventory cameras 310₁-310₈ may be analyzed by the logic of the intelligent shelf 300. The non-transitory computer-readable medium may be local storage, e.g., located at the store in which the proximity sensor 307, the customer recognition camera 30, and/or the inventory cameras 310₁-310₈ reside, or may be cloud-computing storage. Similarly, the one or more processors may be local to the proximity sensor 307, the customer recognition camera 309, and/or the inventory cameras 310₁-310₈, or may be provided by cloud computing services.

Examples of the environment in which the intelligent shelf 300 may be located include, but are not limited to, any type of stores, retailers, lockers/locker units, coolers/cooler units, warehouses, airports, schools such as high schools, colleges, universities, etc., any cafeterias, hospitals such as hospital lobbies, hotels such as hotel lobbies, train stations, and/or any other desired area in which a shelving unit for storing inventory may be located.

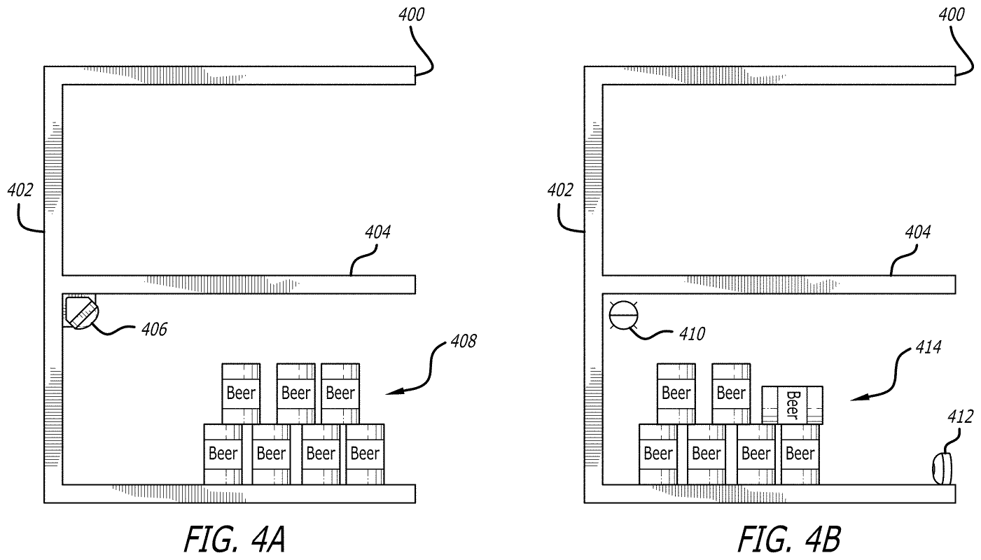

FIGS. 4A-4C are a series of schematic illustrations of an inventory intelligent shelf 400 with one or more sensors coupled to one or more retail displays, in accordance with embodiments of the present disclosure. The inventory intelligent shelves 400 depicted in FIGS. 4A-4C may be similar to the intelligent shelf 300 depicted in FIG. 3. As shown, the sensors may be placed at various positions within, or coupled to, a shelving unit. The utilization of such alternative configurations may be dependent upon the type of shelving unit, the type of inventory being captured in images taken by the sensors, and/or the positioning of inventory within the store environment such as across an aisle. For example, the various configurations depicted below may be configured based on the positioning of particular inventory within the store which includes age restricted inventory like alcoholic beverages, tobacco products, theft-susceptible products, pharmaceutical products, etc. In this example, a variety of sensors and sensor configurations may be implemented on/around/within the particular inventory to facilitate in identifying particular customers with the facial and voice matching recognition capabilities of the various configured sensors, where the particular customers may be approaching or are proximate to the particular inventory, and where the particular customers may need their facial wallets with their age verifications generated to purchase one or more products from the particular inventory.

The one or more sensors are configured to be disposed in a retail environment such as by coupling the sensors to retail displays or warehouse storage units. Such retail displays may include, but are not limited to, shelves, any type of panels such as pegboards, grid walls, slat walls, etc., tables, cabinets, cases, bins, boxes, stands, racks, and/or so on. Such warehouse storage units may include, but are not limited to, shelves, cabinets, bins, boxes, racks, and/or so on. The sensors may be coupled to the retail displays or the warehouse storage units such that: one sensor is provided for every set of inventory items, which may be referred to as one-to-one relationship; one sensor is provided for a number of sets of inventory items, which may be referred to as one-to-many relationship; and/or any combinations thereof. The sensors may also be coupled to the retail displays or the warehouse storage units with more than one sensor for every set of inventory items, which may be referred to as many-to-one relationship, with more than one sensor for a number of sets of inventory items, which may be referred to as many-to-many relationship; and/or any combinations thereof.

In an example of a many-to-one relationship, at least two sensors monitor the same set of inventory items thereby providing contemporaneous sensor data for the set of inventory items. Providing two or more sensors for a single set of inventory item is useful for sensor data redundancy or simply having a backup. Additionally, each of the illustrated figures below depict a one-to-one relationship of a sensor to a set of inventory items, but each sensor may alternatively be in one of the foregoing alternative relationships with one or more sets of inventory items. In embodiments, the sensors 406, 414, 422, 424 depicted below in FIGS. 4A-4C may be comprised of, but not limited to, light- and/or sound-based sensors, which may include digital cameras, microphones, cameras with microphones, and/or any other types of sensors having facial and voice matching recognition processing capabilities. In some embodiments, the sensors 406, 414, 422, 424 depicted below in FIGS. 4A-4C may be comprised of one or more digital cameras or the like, which may be implemented as inventory cameras, customer recognition cameras, facial/voice recognition cameras, etc., having wide viewing angles of approximately 180° or greater. However, it should be understood that any of the sensors 406, 414, 422, 424 depicted below in FIGS. 4A-4C may be positioned at any desired location of the respective shelving unit to provide any desired viewing angles (e.g., including both narrow viewing angles of approximately 180° or less as well as wide viewing angles of approximately 180° or greater), without limitations.

Referring now to FIG. 4A, a schematic illustration of an inventory intelligent shelf 400 with a sensor 406 coupled to a retail shelving unit 404 is shown, in accordance with embodiments of the present disclosure. As shown, in some embodiments, the sensor 406 may be coupled to or mounted on the retail shelving unit 404 under an upper shelf of the shelving unit 404, where the shelving unit 404 may be a component of the housing 402 of the inventory intelligent shelf 400. In the embodiments, the sensor 406 is configured in an orientation to view a set of inventory items 408 on an inventory item-containing shelf beneath the upper shelf. While the sensor 406 is shown mounted inside the retail shelving unit 404 such as on a back pegboard of the housing 402 and looking out from the inventory intelligent shelf 400, the sensor 406 may be alternatively coupled to the upper shelf and looking into the inventory intelligent shelf 400. For example, due to a wide viewing angle of approximately 180° or greater, whether looking out from or into the inventory intelligent shelf 400, the sensor 406 may collect visual information on sets of inventory items adjacent to the set of inventory items 408.

Referring now to FIG. 4B, a schematic illustration of an inventory intelligent shelf 400 with a sensor 412 is shown, in accordance with embodiments of the present disclosure. As shown, in some embodiments, the sensor 412 may be coupled to or mounted on the inventory intelligent shelf 400, particularly on an inventory-item containing shelf in an orientation to view a set of inventory items 414 on the inventory item-containing shelf. While the sensor 412 is shown mounted inside the inventory intelligent shelf 400, on the inventory item-containing shelf, and looking in to the inventory intelligent shelf 400 which may be advantageous when a light 410 is configured in a back portion of the inventory intelligent shelf 400, the sensor 412 may be alternatively coupled to the inventory item-containing shelf and looking out from the inventory intelligent shelf 400. Due to a wide viewing angle of up to approximately 180° or greater, whether looking in to or out from the inventory intelligent shelf 400, the sensor 412 may collect visual information on sets of inventory items adjacent to the set of inventory items 414.

Referring now to FIG. 4C, a schematic illustration of sensors 422 and 424 coupled respectively to inventory intelligent shelves 400 and 416 are shown, in accordance with embodiments of the present disclosure. As shown, in some embodiments, a second housing 418 with a second sensor 424 may be coupled to a second upper shelf 420 and in communication with a second inventory intelligent shelf 416. In certain embodiments, the inventory intelligent shelf 400 and the second inventory intelligent shelf 416 may be separate and independent systems or may be communicatively coupled and/or processing data cooperatively.

In some embodiments, the first sensor 422 may be physically coupled to or mounted on the inventory intelligent shelf 400 in an orientation to view a set of inventory items 428 on an inventory-item containing shelf of an opposing shelving unit across an aisle, such as the second inventory intelligent shelf 416. Likewise, the second sensor 424 may be coupled to or mounted on the second inventory intelligent shelf 416 in an orientation to view a set of inventory items 426 on an inventory-item containing shelf of an opposing shelving unit across an aisle, such as the inventory intelligent shelf 400. Due to wide viewing angles of up to approximately 180° or greater, the first sensor 422 may collect visual information on the sets of inventory items on the second inventory intelligent shelf 416 adjacent to the set of inventory items 428 (not shown), and the first sensor 422 may collect visual information on the sets of inventory items on the second inventory intelligent shelf 416 adjacent to the set of inventory items 426 (not shown).

Additionally, in the embodiments, the sensors 406, 412, 422, and 424 depicted in FIGS. 4A-4C may be coupled to or mounted on endcaps or other vantage points of any inventory intelligent shelves 400, 416—or otherwise such as separate mount (e.g., mounted/attached to a ceiling, a fixture, etc.)—to augment the collected visual information, while also looking into the retail shelving units.

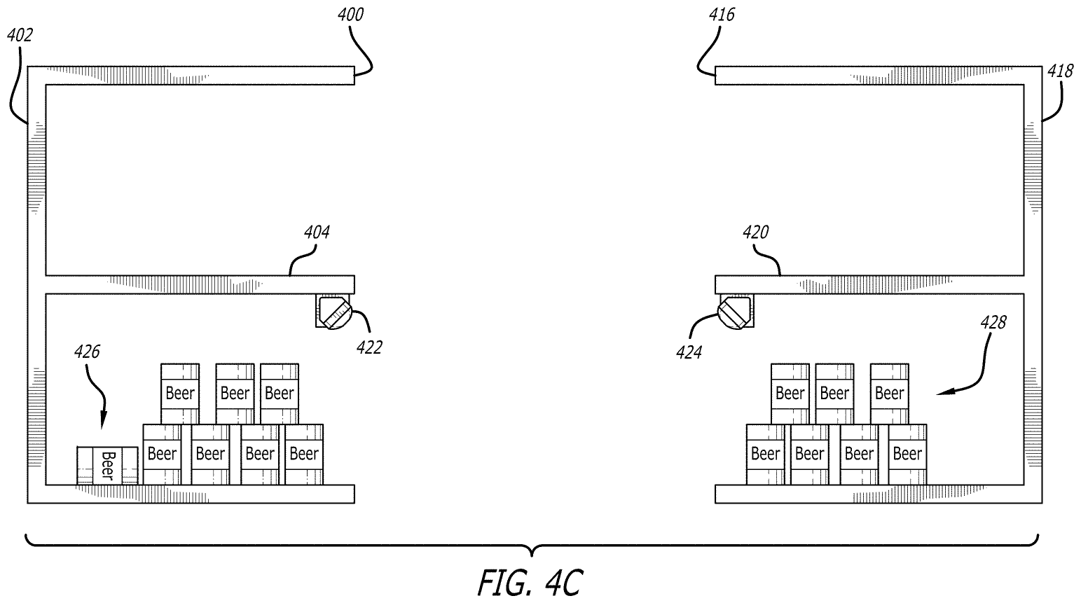

Referring now to FIG. 5, a first logical representation of a frictionless shopping system 500 is shown, in accordance with embodiments of the present disclosure. The frictionless shopping system 500 depicted in FIG. 5 may be similar to the frictionless shopping system 220 depicted in FIG. 2. In the embodiments, the frictionless shopping system 500 may include one or more processors 502 coupled to a communication interface 504. The communication interface 504, in combination with a communication interface logic 508, enables communications with external network devices and/or other network appliances to transmit and receive data. According to some embodiments, the communication interface 504 may be implemented as a physical interface including one or more ports for wired connectors. Additionally, or in the alternative, the communication interface 504 may be implemented with one or more radio units for supporting wireless communications with other electronic devices. The communication interface logic 508 may include logic for performing operations of receiving and transmitting data via the communication interface 504 to enable communication between the frictionless shopping system 500 and network devices via one or more networks (e.g., the Internet), any type of servers, and/or cloud computing servers/services, where, for example, the frictionless shopping system 500 may be communicatively coupled to an enrollment server similar to the enrollment server 160 depicted in FIGS. 1-2.

The one or more processors 502 may be further coupled to a persistent storage 506. According to some embodiments, the persistent storage 506 may store logic as software modules including a frictionless shopping system logic 510 and the communication interface logic 508. The operations of these software modules, upon execution by the processors 502, are described below. Of course, it should be understood that some or all of the logic may be implemented as hardware, and if so, such logic could be implemented separately from each other.

Additionally, the frictionless shopping system 500 may be integrated within an intelligent shelf and include hardware components including fascia 511₁-511ₘ with m≥1, inventory cameras 512₁-512ᵢ with i≥1, proximity cameras 514₁-514ⱼ with j≥1, customer recognition cameras 516₁-516ₖ with k≥1, and voice recognition sensors 518₁-518ₗ with 1≥1. For example, the intelligent shelf described in FIG. 5 may be similar to any of the intelligent shelves depicted in FIGS. 2, 3, and 4A-4C. For the purpose of clarity, couplings, i.e., communication paths, are not illustrated between the processors 502 and the fascia 511₁-511ₘ, the inventory cameras 512₁-512ᵢ, the proximity cameras 514₁-514ⱼ, the customer recognition cameras 516₁-516ₖ, and the voice recognition sensors 518₁-518ₗ; however, the couplings may be direct or indirect and configured to allow for the provision of instructions from the frictionless shopping system logic 510 to any of the respective components.

Each of the inventory cameras 512₁-512₁, the proximity sensors 514₁-514ⱼ, the customer recognition cameras 516₁-516k, and the voice recognition sensors 518₁-518ₗ may be configured to capture images, e.g., at predetermined time intervals or upon a triggering event, and transmit the images to the persistent storage 506. For example, any of the inventory cameras 512₁-512₁, proximity sensors 514₁-514ⱼ, customer recognition cameras 516₁-516ₖ, and voice recognition sensors 518₁-518ₗ may be configured with facial and voice matching recognition processing capabilities, which may be used to generate facial wallets with age verifications for the customers. For example, any of the inventory cameras 512₁-512ᵢmay be implemented as ceiling-mounted cameras which may be used for persistently tracking (i) users throughout the store as well as (ii) objects such as products, coolers, etc., that users may be reaching for or the like. The frictionless shopping system logic 510 may, upon execution by the processors 502, perform operations to analyze the images. Specifically, the frictionless shopping system logic 510 includes customer logic 520, inventory logic 530, and system logic 540. Each of these logics comprise further sub logics, which will be discussed in more detail below. As noted above, the frictionless shopping system 500 may also be implemented with one or more weight and pusher sensors which may be used to capture additional data points associated with that particular frictionless environment.

Generally, the frictionless shopping logic 510 is configured to, upon execution by the processors 502, perform operations to receiving an image or an audio signal from a sensor, where the sensor may be any of the inventory cameras 512₁-512₁, the customer recognition cameras 516₁-516ₖ, and/or the voice recognition sensors 518₁-518ₗ. In the embodiments, the frictionless shopping logic 510 may receive a trigger, such as a request for a determination whether an inventory set needs to be restocked or if a new customer is detected to be within the shopping area, and request an image or an audio signal be captured by one or more of the inventory cameras 512₁-512₁, the customer recognition cameras 516₁-516ₖ, and/or the voice recognition sensors 518₁-518ₗ. In some embodiments, one or more images captured by the inventory cameras 512₁-512ᵢ are processed by the inventory logic 530, while one or more images and/or audio signals acquired from the customer recognition cameras 516₁-516ₖ, the voice recognition sensors 518₁-518ₗ, and/or the proximity sensors 514₁-514ⱼ are processed by the customer logic 520, where the customer logic 520 may cooperate with any of the cameras (or sensors, etc.) described above to track and persistently monitor a customer's session throughout the store.

The inventory logic 530 may comprise an inventory recognition logic 533. The inventory recognition logic 533 is configured to, upon execution by the processors 502, perform operations to analyze an image received by an inventory camera 512₁-512₁, including object recognition techniques (e.g., where one or more of the inventory camera 512₁-512ᵢ may comprise one or more ceiling-mounted tracking cameras (or the like) to implement the object recognition techniques). In the embodiments, the object recognition techniques may include the use of machine learning, predetermined rule sets and/or deep convolutional neural networks. For example, as described above, the object recognition techniques may be used to recognize any variety of objects (e.g., products) in a customer's hand from an image received by a ceiling-mounted tracking camera, an AI object recognition camera, and/or the like, where such cameras may have a narrower field of view (e.g., viewing angles less than 180 degrees) and may be strategically mounted (or positioned) to achieve overlapping camera coverage.

The inventory recognition logic 533 may be configured to identify one or more inventory sets within an image and determine an amount of each product within the inventory set. In addition, the inventory recognition logic 533 may identify a percentage, numerical determination, or other equivalent figure that indicates how much of the inventory set remains on the shelf or stocked relative to an initial amount, for example, based on analysis and comparison with an earlier image and/or retrieval of an initial amount predetermined and stored in a data store, such as the inventory threshold data store 530.

The inventory supply logic 532 is configured to, upon execution by the processors 502, perform a variety of operations including retrieving one or more predetermined thresholds and determine whether the inventory set needs to be restocked. A plurality of predetermined thresholds, which may be stored in the inventory supply logic 532, may be utilized in a single embodiment. For example, a first threshold may be used to determine whether the inventory set needs to be stocked and an alert transmitted to, for example, a retail employee, where the first threshold may indicate that at least a first amount of the initial inventory set has been removed or the like. In addition, a second threshold may be used to determine whether a product delivery person needs to deliver more of the corresponding product to the retailer, where the second threshold may indicate that at least a second amount of the initial inventory set has been removed, the second amount greater than the first amount. In the embodiments, when the second threshold is met, alerts may be transmitted to both a retail employee and a product delivery person.

In further embodiments, the inventory supply logic 532 and inventory recognition logic 533 may be utilized to further the frictionless shopping experience by generating data related to what type of inventory is being selected by shoppers. In such embodiments, the inventory recognition logic 533 may further process images that may generate data to determine what product is being held by a customer, and/or to determine what specific inventory product was grabbed by the customer off of the shelf for purchase. In certain embodiments, the image processing accomplished by the inventory recognition logic 533 may be supplemented by the data generated by the inventory supply logic 532 which may include data related to the location and/or stock quantities related to the products recognized by the image processing. By way of a non-limiting example, the inventory recognition logic 533 may be attempting to determine which product was selected by a customer off of the shelf and has two strong candidates generated. In this case, the selection of which candidate is chosen may be supplemented by accessing inventory supply logic 532 by, for example, recognizing that a first candidate is showing zero stock in the store while the second candidate has multiple items in stock, leading the inventory recognition logic 533 to select the second candidate because it is more likely to be the correct selection based on the known inventory stock data.

It should be understood that the inventory logic 530 may also be supplemented by the customer logic 520 for various processes. By way of a non-limiting example, the inventory recognition logic 533 may again be attempting to determine which product was selected by a customer off of the shelf and has two strong candidates generated based on the image processing. In this case, the selection of which candidate is chosen may be supplemented by accessing customer logic 520 by, for example, recognizing that a first candidate is a product that is routinely purchased by the customer while the second candidate is not typically purchased by the customer, leading the inventory recognition logic 533 to select the first candidate because it is more likely to be the correct selection based on the known customer data, and/or determining quantities when/if other methods are not ascertained (e.g., a user having two bottle openers that are half the weight of a larger bottle opener or a single bottle opener).

In additional embodiments, all data related to inventory utilized by the inventory logic 530 may be stored in an inventory data store 551. It should be understood that the inventory data store 551 may be located within the same persistent storage 506 as the inventory logic 530 as is shown in FIG. 5, but it may also be stored on a separate physical memory storage device that may be located either within the frictionless shopping system 500 or within another device and/or remotely in a cloud-based server.

The inventory logic 530 may also include presentation logic 531 which may store presentation data related to the graphics presented on intelligent shelves. In certain cases, the presentation logic 531 may work in tandem with the proximity logic 524 to generate specific graphics on the intelligent shelf fascia within a first proximity and then to present alternative graphics when the customer is engaged and comes within a closer proximity of the intelligent shelf. In further embodiments, the proximity logic 524 may work in tandem with both the proximity logic 524, but also customer matching logic 526 that may be utilized to present specific graphics on intelligent shelves based upon both the proximity data provided by the proximity logic 524 as well as customer-related data from the customer matching logic 526. In this way, the frictionless shopping system 500 may utilize these data sets to match a customer to their customer data including their facial wallets with their age verifications, to determine when that specific customer is within a given predetermined distance, and then to select and present graphics on at least one intelligent shelf based upon preferences and/or shopping history of that particular customer. Further, embodiments of the presentation logic 531 may include processes for displaying price tags and pricing information upon the customer entering within a predetermined proximity of the intelligent shelf. In many embodiments, the presentation logic 531 may store data related to promotional campaigns and/or customer engagement in the engagement data store 553. It should be understood that the engagement data store 553 may store data related to various aspects of tracking customer engagement with the various promotions for the purpose of creating metrics or other data that may be utilized by stores or inventory manufacturers to increase sales or provide insight into customer shopping trends and/or practices.

The customer logic 520 is configured to, upon execution by the processors 502, perform operations related to data associated with the customers. In the embodiments, the customer logic may comprise several sub-logics with their own functions. In the embodiments depicted in FIG. 5, the customer logic 520 may comprise skeletal recognition logic 521, hand tracking logic 522, three-dimensional mapping logic 523 (shown as “3D mapping logic”), proximity logic 524, gaze tracking logic 525, customer matching logic 526, facial recognition logic 527, and/or voice recognition logic 528.

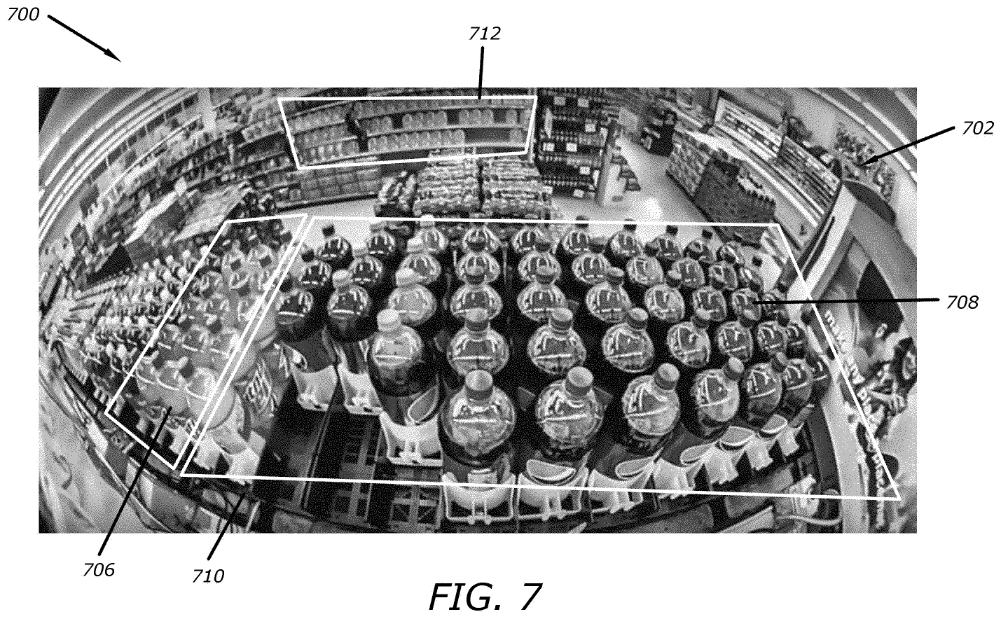

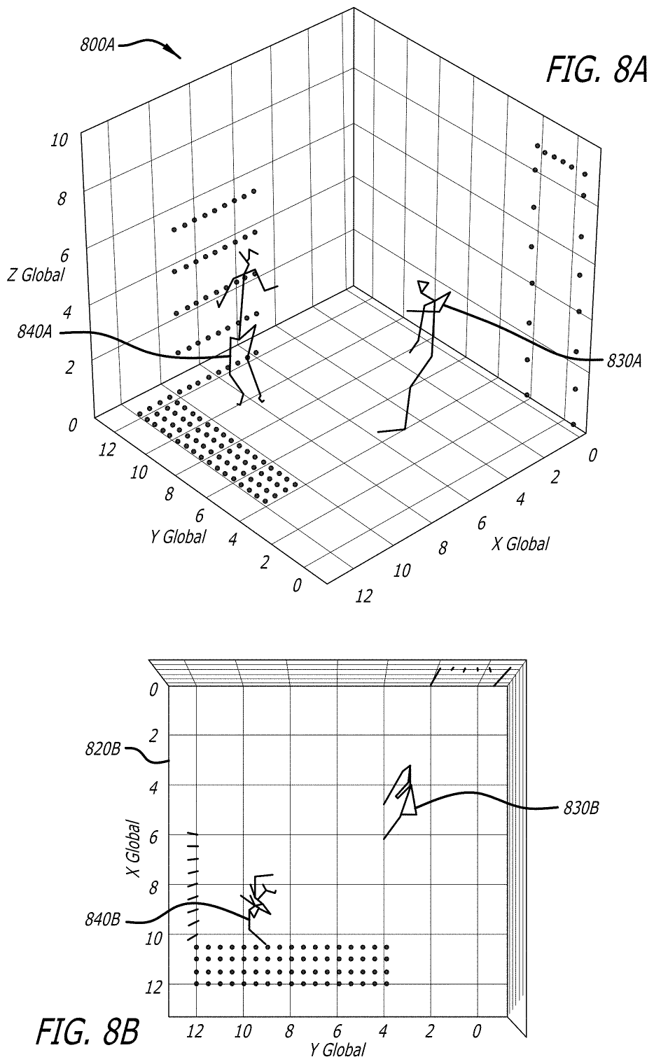

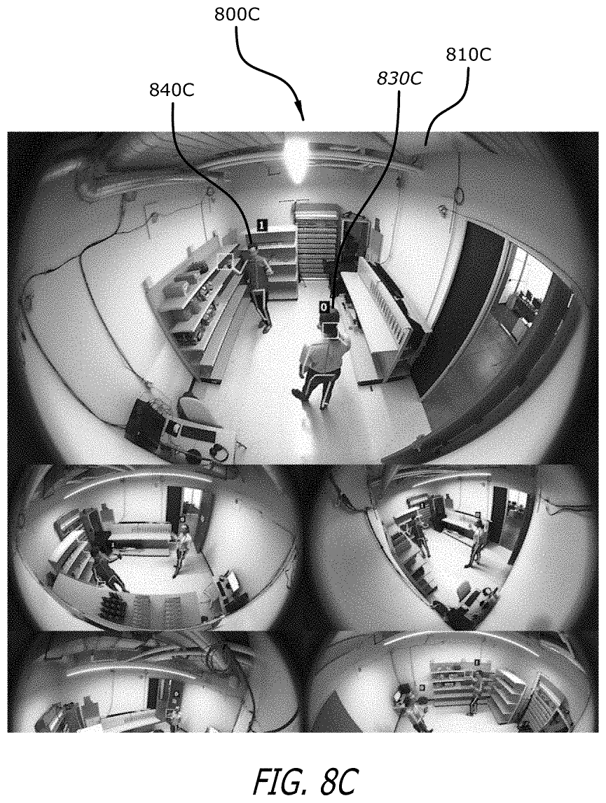

In some embodiments, the customer logic 520 may include a skeletal recognition logic 521. Skeletal recognition may be done through the processing of image data generated by any of the sensors/cameras on the intelligent shelving units. In certain embodiments, the captured image data is supplemented by depth map data. As depicted below in further details in FIGS. 8A-8C, the frictionless shopping system 500 may acquire image data of a given shopping area and attempt to extract the location of a variety of limbs, joints, head, and/or torso locations of customers within the image. In many embodiments, the generation of such data may aid the frictionless shopping system 500 to determine how many customers are within the shopping area, what direction they are facing, and where they are in relation to the one or more intelligent shelves. In certain embodiments, this skeletal recognition data may be utilized by other logics for supplemental processing including, for example, the gaze tracking logic 525 which may be aided in a determination of the direction of a customer's gaze based on the determined location of the customer within the shopping area. Furthermore, the three-dimensional mapping logic 523 may be aided in generating a three-dimensional model of the shopping area by utilizing the skeletal recognition data in relation to the images that are being processed, and/or aided in persistently tracking a customer's shopping session across multiple cameras and understanding any customer-related actions such as reaching, grabbing, etc. (e.g., in view of alcohol sales, this helps when a store's compartment, such as coolers, lockers, cabinets, etc., may be locked initially and may be subsequently unlocked automatically in real time when an age-verified customer reaches towards such compartment).

The skeletal recognition logic 521 may utilize a number of tools to aid in the generation of skeletal recognition data including, but not limited to, image recognition on a plurality of two-dimensional images, machine-learning algorithms applied to images with corresponding depth map data (RGB-D), synthesizing data across multiple cameras, and/or statistical modeling to generate improved results such as Markov models or the like. It should be understood that any variety of machine learning, predetermined rule sets, and/or deep convolutional neural networks may be utilized to successfully generate truthful skeletal representations of customers within the shopping area. It is further contemplated that training of the skeletal recognition logic 521 may be done via multiple methods including establishing ground truth data within a controlled lab, incorporating a third-party set of data, and/or training the skeletal recognition logic 521 in the store with real-world experiences. In certain embodiments, the skeletal recognition logic 521 may be aided in its determination and generation of skeletal recognition data by a communication link received from the mobile computer device of the customer within the store (e.g., a smart phone sending compass/directional information to the frictionless shopping system 500.)

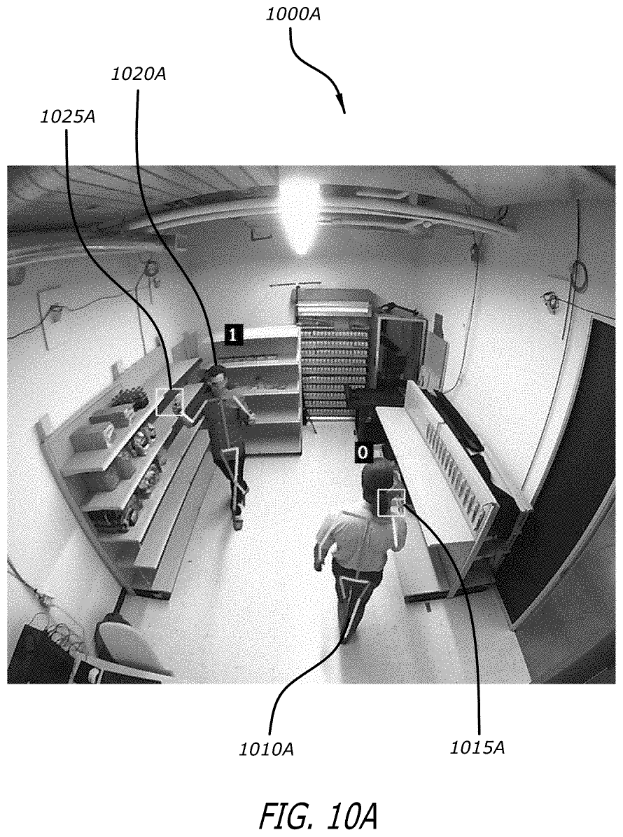

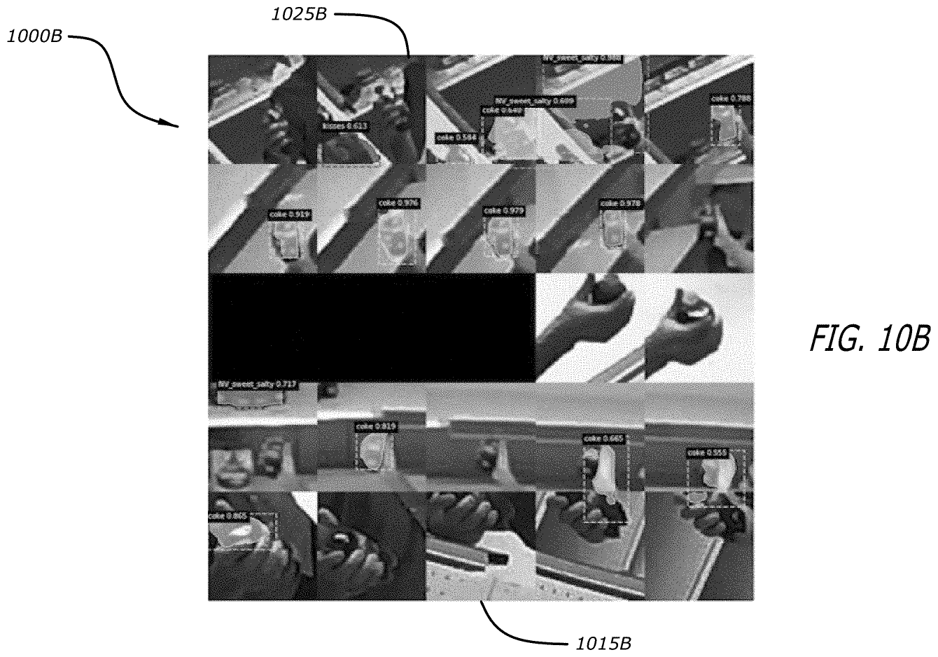

The frictionless shopping system 500 may also comprise hand tracking logic 522 that may be utilized to track the hand of customers within the shopping area. In various embodiments, the hand tracking logic 522 may track the hands of customers to verify that they are holding a product as depicted in FIG. 10B. Hand tracking techniques may be accomplished through a variety of technologies including, but not limited to, computer vision algorithms, neural network processing, and/or inverse kinematics principles. In certain embodiments, the hand tracking logic 522 may be configured to accept a third-party application program interface (API) or software development kit (SDK) to aid in the generation of hand tracking data. In many embodiments, a goal of the hand tracking logic 522 is to generate hand tracking data that represents the location, orientation, and extension of customer's hands within the three-dimensional shopping space within a given shopping area. This may typically be accomplished by attempting to infer various location points across the hand relating to features such as joints, digits, wrists, and palms.

Similar to the skeletal recognition logic 521, the hand tracking logic 522 may utilize a number of tools to aid in the generation of skeletal recognition data including, but not limited to, image recognition on a plurality of two-dimensional images generated from a plurality of cameras, machine-learning algorithms applied to images with corresponding depth map data (RGB-D), and/or statistical modeling to generate improved results.

It is also contemplated that any variety of machine learning, predetermined rule sets, and/or deep convolutional neural networks may be utilized to successfully generate truthful hand representations of customers within the shopping area. It is further contemplated that training of the hand tracking logic 522 may be done via multiple methods including establishing ground truth data within a controlled lab, incorporating a third-party set of data, and/or training the hand tracking logic 521 in a store with real-world experiences and feedback directed by a system administrator.

It should be understood that the three-dimensional mapping logic 523 may be aided in generating a three-dimensional model of the shopping area by utilizing the hand tracking data in relation to the images that are being processed, without limitations. Ultimately, the hand tracking data may be beneficial to other logics that determine whether a customer has selected and grabbed an item off of an intelligent shelf for purchase, for example, such as an age restricted item that may trigger one or more other logics to identify the customer who grabbed the age restricted item and then determine whether a facial wallet with an age verification needs to be generated for the customer. Similarly, the hand tracking data (or object tracking data) may be beneficial when age restricted items are locked in a cooler, locker, cabinet, etc., which may be configured to automatically unlock in real time as an age-verified customer (i.e., a customer having a facial wallet with an age verification) reaches towards the handle (or the like) of the cooler, locker, cabinet, etc. Additionally, continued tracking of the product beyond when it is grabbed off of the shelf, may yield further data regarding customer engagement if the product is ultimately put back by the customer and/or carries the inventory around and does not put the product in the basket and/or shopping cart. This type of data may yield insight into customer shopping habits as the time required to place an item from inventory from a shopper's hand into a shopping cart/basket may relate to shopping decisions still being made, which could be useful for the generation of shopping metrics for various parties including the frictionless shopping system administrators and the producers of the inventory being selected.

To aid in the understanding of the shopping area, the frictionless shopping system 500 may comprise three-dimensional mapping logic 523. In many embodiments, the generation of a three-dimensional model may aid in the generation of data related to customer selection. An example of a generated three-dimensional model is depicted in FIG. 8A, in accordance with some embodiments of the disclosure. In certain embodiments, data generated from skeletal recognition logic 521, and hand tracking logic 522 may be utilized to aid in the generation of the three-dimensional model data. In certain embodiments, the three-dimensional mapping logic 523 may also be utilized to generate two-dimensional or pseudo-two-dimensional models similar to the model depicted in FIG. 8B. It should be understood that a variety of machine learning, predetermined rule sets, and/or deep convolutional neural networks may be utilized to successfully generate data relating to an approximate representation of the three-dimensional shopping area with a plurality of models representing customers present within the shopping area. In further embodiments, the three-dimensional mapping logic 523 may also generate models representing inventory and its location within the three-dimensional space.

The proximity logic 524 is configured to, upon execution by the processors 502, perform operations to analyze images or other signals received from the proximity sensors 514₁-514ⱼ. In the embodiments, the proximity logic 528 may determine when a customer is within a particular distance threshold from the shelving unit on which the inventory set is stocked and transmit one or more communications, such as instructions, commands, etc., to change the graphics displayed on the fascia 511₁-511ₘ. In the embodiments, data related to proximity may be stored within a proximity data store 552. Similar to the other data stores, the proximity data store 552 may be located within the same persistent storage 506 as the customer logic 520 as is shown in FIG. 5, but it may also be stored on a separate physical memory storage device that may be located either within the frictionless shopping system 500 or within another device and/or remotely in a cloud-based server.

In a variety of embodiments, the frictionless shopping system 500 may comprise gaze tracking logic 525 that may generate data relating to the location of a customer's visual gaze. It is widely understood that a shopper's gaze may yield insightful data relating to the customer's decision-making process, receptiveness to visual campaigns utilized, and/or reaction to pricing data. It should be understood that gaze tracking logic 525 may utilize a variety of machine learning, predetermined rule sets, and/or deep convolutional neural networks to generate data relating to gaze tracking.

Gaze tracking data may be generated in a variety of forms including, but not limited to, heat maps, static location data, and/or linear line maps. The methods of gaze tracking typically involve image processing of images captured from a plurality of cameras. In certain embodiments, the images utilized for gaze tracking are captured from a color camera and/or an infrared camera.

In embodiments, the frictionless shopping system 500 may comprise customer matching logic 526. The customer matching logic 526 may be utilized for a variety of operations including, but not limited to, determining trends of the customers or gathering data related to the customers based on ethnicity, age, gender, time of visit, geographic location of the store, weather, and so on. Based on additional analysis, the frictionless shopping system logic 510 may determine trends in accordance with a variety of factors including, but not limited to, graphics displayed by the frictionless shopping system 500, sales, time of day, time of the year, day of the week, etc. The customer matching logic 526 (in conjunction with the facial and/or voice recognition logics in some embodiments) may be utilized to access customer information and/or customer accounts and associated data within a customer data store 554. The customer matching logic may then match a customer recognized within a shopping area or store with a customer account stored as customer account data within the customer data store 554, and/or respectively generate a facial wallet with an age verification for the recognized customer to purchase any age restricted products. This generated facial wallet can be linked with the customer and their customer account data. Any customer related data generated during frictionless shopping such as any facial and/or voice recognition data may be added to the customer data store 554 and associated with a specific customer account or anonymized and stored for future analysis.

Customer matching may be accomplished utilizing other customer and inventory logics. Matching may also be accomplished through the utilizing data received from a customer's mobile computing device in communication with the frictionless shopping system 500. By way of a non-limiting example, in one approach, a customer may enter a store with a mobile phone that is loaded with an application that may create a data connection with the frictionless shopping system 500, while, in another approach, a customer may scan a QR code (e.g., the QR code may be located a mobile computing device, a badge, an ID, etc.) on a reader device to create a data connection within any of one or more frictionless shopping environments (e.g., such as within a company location, a store, a warehouse, a hotel, etc.). Upon entering the store, the application may utilize GPS data to determine that the customer is within a store and transmits the data to the frictionless shopping system 500. Based upon this data, the frictionless shopping system 500 may determine that a particular customer determined to be within the shopping area is the customer associated with the application account. Data regarding the customer's age, height, etc. may be utilized to further match a recognized customer with an account associated with the customer, which may be also utilized to determine whether the recognized customer is associated with a facial wallet with an age verification that may allow the recognized customer to purchase any age restricted products.

Upon matching the customer, all relevant data may be associated between the customer detected within the shopping area, and the customer account info that has been derived. In certain embodiments, the relevant data may include demographics data, shopping history/patterns, age verification data, and/or payment/preauthorization rules which may be associated with an authorized method of payment the customer has set up in their account.

The facial recognition logic 527 and/or the voice recognition logic 528 may be configured to, upon execution by the processors 502, perform operations to analyze images and/or audio signals from at least one or more of any facial recognition cameras 516₁-516ₖ and/or voice recognition sensors 518₁-518ₗ. In the embodiments, the facial recognition logic 526 and/or the voice recognition logic 528 may be utilized to identify customers with their account data such as their facial wallets with associated age verifications, and to determine trends in the customers based on ethnicity, age, gender, time of visit, geographic location of the store, etc., and, based on additional analysis, the inventory intelligent shelf logic 510 may determine trends in accordance with graphics displayed by the frictionless shopping system 500, sales, time of day, time of the year, day of the week, etc.

In many embodiments, a set of training logic 541 is a sub-set of the system logic 540. The training logic 541 may be comprised of data necessary for the various image processing algorithms utilized in other logics. It should be understood that the training data may be provided by a third-party vendor or inventory manufacturer. In further embodiments the training logic 541 may be updated and/or trained after the frictionless shopping system 500 installation. The training logic 540 may be provided periodically or non-periodically based on the needs to the application. By way of a non-limiting example, updates may be provided from the manufacturer for new products. By way of another non-limiting example, the training logic 540 may be configured to use 3D scanning and procedurally-generated synthetic training data (i.e., training images which are 3D-rendered using a combination of models and/or real images), and/or to capture images as users shop and of their respective behavior patterns (e.g., various training images may be captured from scenarios such as a new product being loaded into a planogram and one or more users moving to grab the new product).

In many embodiments, the frictionless shopping system 500 may be coupled with a plurality of intelligent shelving units that may include a plurality of facial recognition cameras 516₁-516ₖ. Each intelligent shelf may cover a predetermined shopping area. Stores may contain large shopping areas that need multiple intelligent shelves to cover the entire desired shopping area. In some embodiments, data handoff logic 542 may facilitate a transfer of data between cameras, shopping areas, aisles, intelligent shelves, and so on. By way of example, and not limitation, a first intelligent shelf may process data related to recognizing customers in a first shopping area using a first camera (e.g., a first overhead camera), while the customer travels outside of the first shopping area and into a second shopping area associated with a second intelligent shelf using a second camera (e.g., a second overhead camera). In this instance, the data handoff logic 542 may facilitate and transfer the data necessary for further processing from the first shopping area to the second shopping area—and to any associated components of the second shopping area. It should be understood that the data handoff logic 542 may further handoff data for processing to remote systems, servers, and/or other cloud services for further processing. In a number of embodiments, the data required to be transmitted or received as part of the hand off process may be stored within a handoff data store 555.

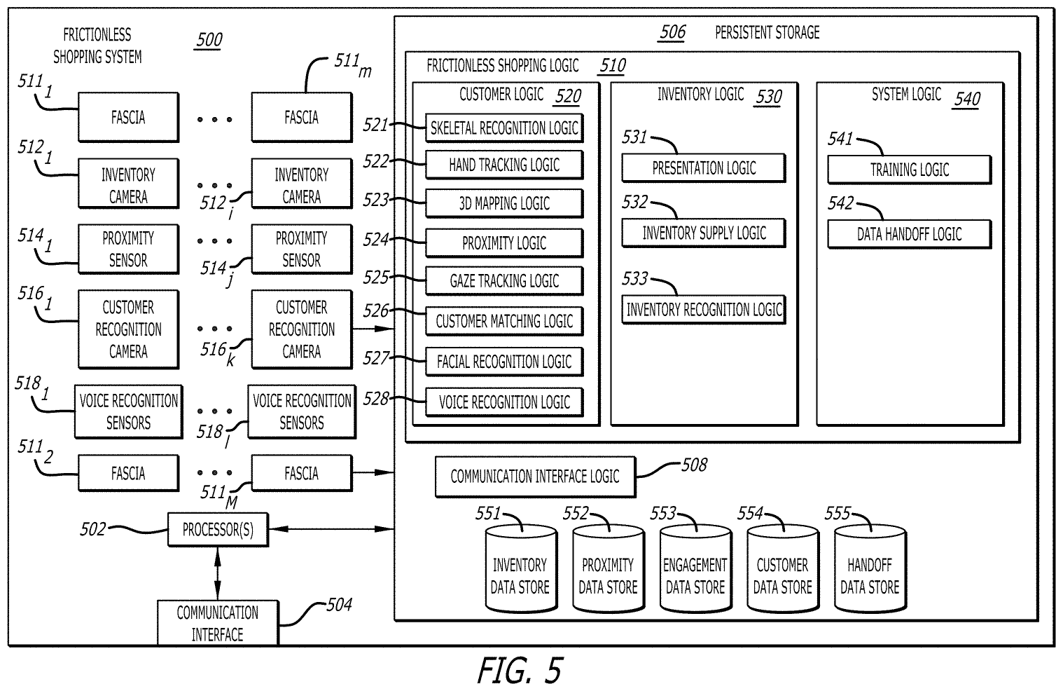

Referring now to FIG. 6, a second logical representation of a frictionless shopping system 600 is shown, in accordance with embodiments of the present disclosure. The frictionless shopping system 600 depicted in FIG. 6 may be similar to the frictionless shopping system 500 depicted in FIG. 5, however frictionless shopping system 600 may not be directly embedded or attached to an intelligent shelf, where the logics and data stores utilized may be remotely located apart from the frictionless shopping system 600.

In certain embodiments, the frictionless shopping system 600 may be realized as a standalone device that may be physically located away from the intelligent shelving units with a communication interface 604 that may communicate with the remote frictionless shopping logic 610 and data stores 651, 652, 653, 654, 655. In further embodiments, the frictionless shopping system 600 may be realized in a device not initially configured to be a frictionless shopping system 600, but already contains the necessary components and may have the functionality necessary to become a frictionless shopping system 600 via an update such as, but not limited to, a software and/or firmware update. In this way, the frictionless shopping system 600 may be added to a pre-existing intelligent shelf system without the need to add new hardware to the intelligent shelves. The communication between the frictionless shopping system 600 and the intelligent shelves associated with the shopping areas to be processed with the communication logic 608 of the frictionless shopping system 600.

Similar to the frictionless shopping system 500 depicted in FIG. 5, the frictionless shopping system 600 may comprise one or more processors 602 that are coupled to a communication interface 604. The communication interface 604, in combination with a communication interface logic 608 stored within a persistent storage 606, enables communications with external network devices and/or other network appliances to transmit and receive data. Many embodiments may communicate with a frictionless shopping server 110 as depicted in FIG. 1 in order to communicate and process logics and utilize data stores. According to some embodiments, the communication interface 604 may be implemented as a physical interface including one or more ports for wired connectors. Additionally, or in the alternative, the communication interface 604 may be implemented with one or more radio units for supporting wireless communications with other electronic devices. The communication interface logic 608 may include logic for performing operations of receiving and transmitting data via the communication interface 604 to enable communication between the frictionless shopping system 600 and network devices via one or more networks, servers, and/or cloud computing servers/services, where, for example, the frictionless shopping system 600 may be communicatively coupled to an enrollment server similar to the enrollment server 160 depicted in FIGS. 1-2.

The communication interface 604 is further in communication to a remote storage 660. According to some embodiments of the disclosure, the remote storage 660 may store logic as software modules including the frictionless shopping logic 610 along with various data stores 651, 652, 653, 654, 655. The operations of these logics, upon execution by the processors 602, are similar to the descriptions of the respective logics depicted with the frictionless shopping logic 510 above in FIG. 5. It should be understood that some or all of this logic may be processed either locally and/or remotely by a cloud/edge server. In other embodiments, the processing is done by the processors 602 within the frictionless shopping.

Referring now to FIG. 7, an illustration of an image 700 captured by a camera of a frictionless shopping system is shown, in accordance with embodiments of the present disclosure. Similarly, in other embodiments, the image 700 may be captured by one or more cameras associated with an automated inventory intelligence (AII) system, where the AII system may be used in conjunction with the frictionless shopping system and/or used as a standalone system._The image 700 depicted in FIG. 7 illustrates the ability of an inventory camera or the like configured for use with a variety of embodiments of frictionless shopping systems, including the frictionless shopping systems 220 and 500 depicted in FIGS. 2 and 5. The inventory camera may capture the image 700 having approximately a 180° viewing angle or greater. In some embodiments, an inventory camera, such as the inventory camera 310₁ of FIG. 3, may be positioned within a shelving unit, such as the shelving unit 302 of FIG. 3, such that the inventory camera is located at the inner rear of the shelving unit and above a portion of inventory. In such an embodiment, the inventory camera 310₁ may capture an image such as the image 700, which includes a capture of an inventory portion 708 and an inventory portion 710 stocked on shelving 706. In addition, the image 700 may include a capture of a portion of the store environment 702 and additional inventory 712.

Specifically, the positioning of the inventory camera as shown in FIG. 7 enables the inventory camera to capture images such as the image 700, which may be analyzed by logic of the frictionless shopping system to automatically and intelligently determine a variety of information including, but not limited to, the amount of inventory stocked on the shelf, the type of inventory stocked on the shelf, the SKU of the inventory stocked on the shelf, and/or if inventory has been removed or replaced on the shelf by a customer or vendor. For example, as depicted with the image 700, the inventory portion 708 and the inventory portion 710 may be identified by the frictionless shopping system using various object recognition techniques. For example, upon recognition of the inventory portion 708 such as recognition of Pepsi bottles or the like, logic of the frictionless shopping system may analyze the quantity remaining on the shelf 706. In some embodiments, the frictionless shopping system may determine whether a threshold number of bottles have been removed from the shelf 706. Upon determining that at least the threshold number of bottles have been removed, the frictionless shopping system may generate a report and/or an alert notifying employees of the store that the inventory portion 708 requires restocking. In other embodiments, the frictionless shopping system may determine that less than a threshold number of bottles remain on the shelf 706 and therefore the inventory portion 708 requires restocking. Utilization of other methodologies of determining whether at least a predetermined number of items remain on a shelf for a given inventory set are within the scope of the embodiments of the present disclosure. As described above, the inventory set may include a grouping of particular items/products, e.g., a grouping of a particular type of merchandise, which may include brand, product size (12 oz. bottle v. 2 L bottle), etc.

In further embodiments, the frictionless shopping system may utilize data generated from the image 700 to help determine if a customer has removed an item from the shelf. By way of a non-limiting example, and as further illustrated below in the discussion of FIGS. 10A-10B, the frictionless shopping system may couple data regarding determined stock levels with data generated from cameras that may track and determine if the customer is holding a product and/or where that product was grabbed from, where the product may be an age restricted product. In this way, the frictionless shopping system may correlate the data of inventory location with the data related to customer location and pose to generate probability data that may be used to determine if a customer has removed a product from the shelf.

In the embodiments, the image 700 may also be analyzed to determine the remaining items of other inventory portions such as the inventory portion 706 and/or the alternative portion 712. It should be understood that the inventory cameras may be placed at various varying positions within, or coupled to, a shelving unit, without limitations. The utilization of such alternative configurations may be dependent upon the type of shelving unit, the type of inventory being captured in images taken by the inventory camera and/or the positioning of inventory within the store environment, such as across an aisle.

Referring now to FIG. 8A, an illustration of a three-dimensional shopping area space generated by a frictionless shopping system is shown, in accordance with embodiments of the present disclosure. The depicted image covers an embodiment wherein the three-dimensional mapping logic has generated data representing a three-dimensional model 800A of the shopping area, along with a first customer 830A and a second customer 840A. The depicted embodiment also generates data representing the customers 830A, 840A as skeletal structures. The three-dimensional model 800A depicted in FIG. 8A illustrates the ability of a recognition camera or the like configured for use with a variety of embodiments of frictionless shopping systems, including the frictionless shopping systems 220 and 500 depicted in FIGS. 2 and 5. It should be understood that such skeletal structure generation is aided by the use of the skeletal recognition logic when processing the images used to represent the shopping area depicted by the three-dimensional space 800A, without limitations.

Referring now to FIG. 8B, an illustration of an overhead two-dimensional shopping area space generated by the frictionless shopping system in accordance with some embodiments is shown. Similar to the generated three-dimensional data shown in FIG. 8A, the data generated in FIG. 8B processes the same data to realize a two-dimensional overhead view 820B with a first shopper 830B and a second shopper 830B. In the depicted embodiment, the two-dimensional image 820B, and respective first and second shoppers 830B and 840B represent the same data as shown in FIG. 8A. The two-dimensional model 820B depicted in FIG. 8B illustrates the ability of a recognition camera or the like configured for use with a variety of embodiments of frictionless shopping systems, including the frictionless shopping systems 220 and 500 depicted in FIGS. 2 and 5. Although the figures depict the same instant in a particular shopping experience, it should not be construed that this must always be the case. It should be understood that the generation of three-dimensional and two-dimensional items may be generated separately, or by separate image capturing systems/devices within the frictionless shopping system and be utilized through comparison and/or matching to better generate data that yields a higher confidence level for further processing.

Referring now to FIG. 8C, an illustration of a series of images 800C captured by a plurality of customer recognition cameras of a frictionless shopping system is shown, in accordance with embodiments of the present disclosure. The captured images 800C depicted in FIG. 8C illustrates the ability of a recognition camera or the like configured for use with a variety of embodiments of frictionless shopping systems, including the frictionless shopping systems 220 and 500 depicted in FIGS. 2 and 5. Customer recognition cameras may be installed within the intelligent shelving devices or may be installed independently around the store. The customer recognition cameras may capture multiple angles of a given shopping area similar to the images 800C in FIG. 8C. By way of illustration, the top shopping area image 810C shows two customers 830C, 840C during a sample shopping process. The images captured from a customer recognition camera are processed to generate data related to the shopping environment. In many embodiments, the processing includes determining a skeletal structure of the customers 830C, 840C within the shopping area. As depicted above in the discussion of the customer logic 520 of FIG. 5, the frictionless shopping system may employ skeletal tracking, hand tracking, gaze tracking, and facial/voice recognition logics when processing and analyzing the captured customer image data. It should be understood that the customer recognition cameras may be either standard RGB cameras or depth cameras with infrared or other depth sensors.

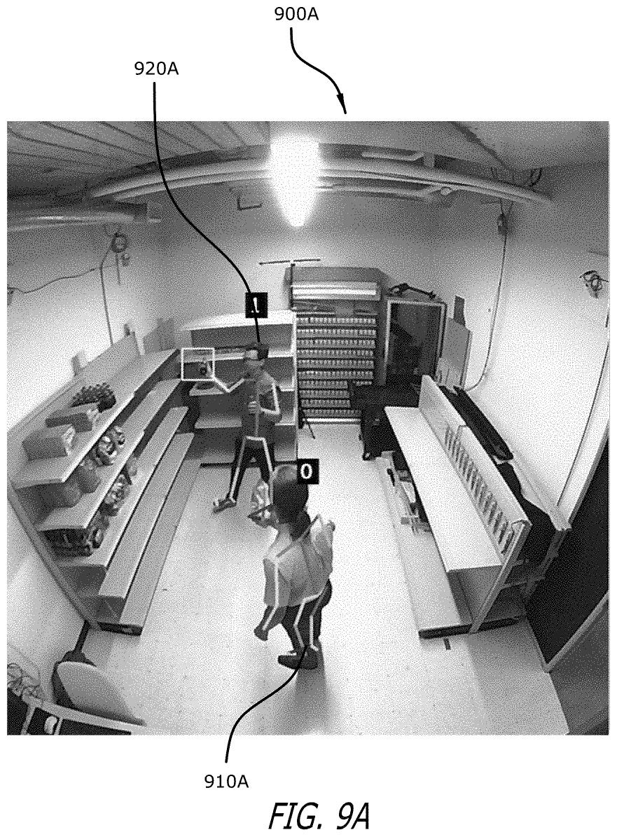

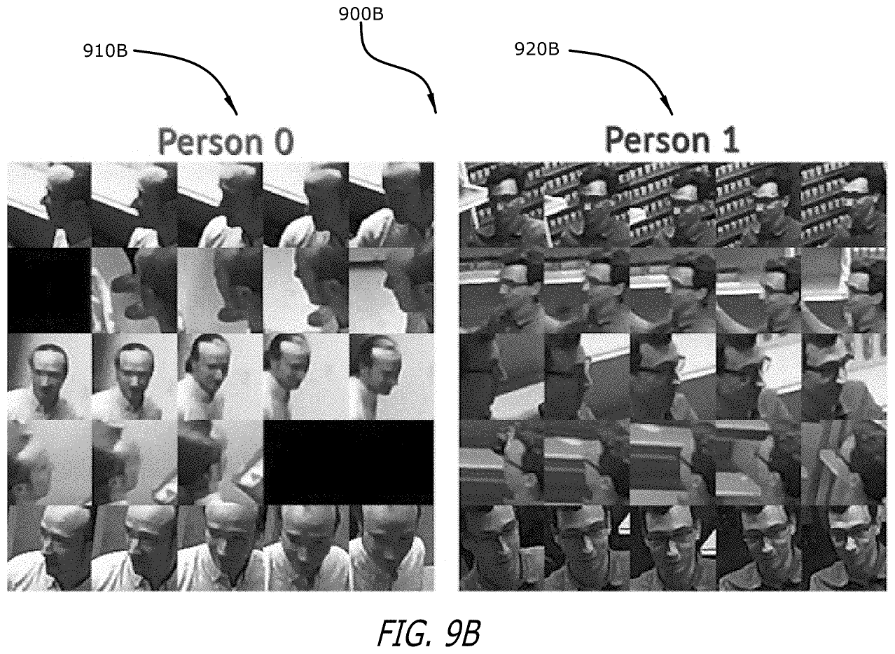

Referring to FIG. 9A, an illustration of an image 900A being processed with skeletal recognition techniques captured by a customer recognition camera of a frictionless shopping system is shown, in accordance with embodiments of the present disclosure. The captured image 900A depicted in FIG. 9A illustrates the ability of a customer recognition camera or the like configured for use with a variety of embodiments of frictionless shopping systems, including the frictionless shopping systems 220 and 500 depicted in FIGS. 2 and 5. In a number of embodiments, the frictionless shopping system may generate data associated with skeletal structures of customers within a shopping area. Techniques for such image processing are explained above in more detail within the discussion of skeletal recognition logic in FIG. 5. In the illustrated embodiment, a customer recognition camera captures image data from a shopping area that comprises a first customer 910A and a second customer 920A. In some embodiments, part of the customer recognition process comprises determining a skeletal structure that corresponds to the customer within the shopping area. Such generated skeletal data may be overlaid with the actual customer as depicted in FIG. 9A. In this way, it may be observed that the generated skeletal recognition data is an accurate representation of the customers. It should be understood that customer recognition methods, such as skeletal recognition, overall appearance detection (e.g., such as attire, gait, etc.), and facial/voice recognition, may include generating confidence intervals though a variety of image processing, machine learning, predetermined rule sets, and/or deep convolutional neural networks. Similarly, it should be understood that such techniques may be generated through the use of third party software and methods, without limitations.

Referring to FIG. 9B, an illustration of multiple images 900B being processed with customer recognition techniques captured by a customer recognition camera of the frictionless shopping system in accordance with some embodiments is shown. The captured images 900B depicted in FIG. 9B illustrates the ability of a customer recognition camera or the like configured for use with a variety of embodiments of frictionless shopping systems, including the frictionless shopping systems 220 and 500 depicted in FIGS. 2 and 5. As depicted above within the discussions of the facial and voice recognition logics of FIG. 5, embodiments of the frictionless shopping system may process images captured from customer recognition cameras, voice recognition sensors, combinations thereof, and/or the like to generate facial recognition data—and, in some embodiments, voice recognition data when desired.

The pair of images 900B depict a successive series of selected locations within a larger series of image captures wherein the frictionless shopping system has determined with a confidence level above a predetermined threshold to be the face of a customer. The examples depicted in FIG. 9B are respective captures of the customers facial data of customers 910A, 920A as shown in FIG. 9A. In the illustrated embodiments, the left image 910B depicts a series of images that show the frictionless shopping system tracking the face of the first customer 910A. Likewise, the right image 920B depicts a series of images that show the frictionless shopping system tracking the face of the second customer 920A.

The images depicted in FIG. 9B should be understood to be selections the frictionless shopping system has made from the full image of the entire shopping area. Image processing techniques may be utilized along with various machine learning, predetermined rule sets, and/or deep convolutional neural networks to make decisions on which area of the image to focus on and analyze. The selection of an area of a larger image may then be passed to other logic that may further determine other characteristics including, customer identification such as age verification or the like, customer demographics such as name, address, sex, and age, gaze detection, and/or other engagement data. For example, the images 910B, 920B depicted in FIG. 9B may be used to then identify that only the customer 910B has enrolled with an enrollment server similar to the enrollment server 160 depicted in FIGS. 1-2, as such the frictionless shopping system may generate a facial wallet with an age verification for the customer 910B—and not for the customer 920B—which may be used to purchase any age restricted products without needing an ID and/or needing an in-person review of the ID prior to purchasing/leaving the store with the age restricted product. It should be understood that such techniques may also be helpful for store loss prevention.

Referring to FIG. 10A, an illustration of an image 1000A being processed with inventory recognition techniques captured by an inventory camera of a frictionless shopping system is shown, in accordance with embodiments of the present disclosure. The captured image 1000A depicted in FIG. 10A illustrates the ability of a recognition camera or the like configured for use with a variety of embodiments of frictionless shopping systems, including the frictionless shopping systems 220 and 500 depicted in FIGS. 2 and 5. The captured image 1000A depicts a first customer 1010A with a first item of inventory 1015A in his right hand, as well as a second customer 1020A carrying a second item of inventory 1025A in his right hand. In many embodiments, the frictionless shopping system may take multiple images over time and apply image processing techniques to better identify whether a product is in a customer's hand and/or to potentially determine what the product is. For example, determining whether the product is an age restricted product which may be used to further identify the customer who grabbed the product, and determine whether the customer is associated with a facial wallet for an age verification to be able to purchase the age restricted product.

It should be understood that such identification techniques may vary and may include tools and/or techniques developed by third parties. In many embodiments, the image processing techniques generate an overall probability of confidence that may be manipulated over a period of time and images and subsequently be utilized by other logics for determination of what inventory product 1015A, 1025A was pulled off of the shelves and whether the inventory product is being carried or held by the customers 1010A, 1020A. It should be understood that multiple cameras may be utilized to generate images from multiple angles of the same shopping area which may aid the image processing techniques by providing images of the product, even when the product may be secluded or other obfuscated by other objects including, but not limited to, the customer.

In many embodiments, the first customer 1010A can be tracked while entering shopping area that includes one or more smart shelving units with at least one restricted access area. During tracking of the first customer 1010A, the frictionless shopping system can begin to match the tracked first customer 1010A with a known customer within a database, enrollment system, or other data store. The customer data, account, etc. may have a previously generated or associated facial wallet that can include a verified age of the tracked first customer 1010A. Based on this pre-verified age within the facial wallet of the customer account, when the first customer 1010A approaches a restricted access area, the frictionless shopping system can be configured to automatically grant access to the first customer 1010A. In some embodiments, the frictionless shopping system may ask for a voice or other prompt from the first customer 1010A before granting access, such as, but not limited to, requesting the first customer 1010A speak or verify their voice into their mobile computing device running the companion mobile shopping application.

Upon granting of access to the restricted area, the first customer 1010A may select a restricted product. Access to further restricted products may then be limited, but access upon verification can last various amounts of time and under different circumstances depending on the application desired. For example, the restricted access area may close after a predetermined amount of time, or may lock or otherwise become restricted upon the first customer 1010A leaving the shopping area or moving a predetermined distance from the restricted access area.

Additionally, the frictionless shopping system can, in many embodiments, track the age-restricted product until it is either purchased by the first customer 1010A (by leaving or other checkout process) or until it is returned to the shelf. In certain embodiments, the first customer 1010A may be notified or otherwise prompted to attend to the age-restricted product if it is not returned to proper area or purchased. For example, if the first customer 1010A takes an age-restricted product from a restricted access area, and then sets it down in a non-restricted access area, the companion mobile shopping application may generate a notification or other alert to the first customer 1010A that the age-restricted product has not been properly taken care of. Similar notifications can be made if another tracked customer who does not have an associated pre-verified age satisfying the predetermined age threshold of the age-restricted product within their facial wallet picks up or otherwise takes possession of the age-restricted product.

Referring now to FIG. 10B, an illustration of multiple images being processed with inventory recognition techniques captured by an inventory camera of a frictionless shopping system is shown, in accordance with embodiments of the present disclosure. The captured images 1000B depicted in FIG. 10B illustrates the ability of a recognition camera or the like configured for use with a variety of embodiments of frictionless shopping systems, including the frictionless shopping systems 220 and 500 depicted in FIGS. 2 and 5. The pair of images 1000B depict a successive series of selected locations within a larger series of image captures, where the frictionless shopping system has determined with a confidence level above a predetermined threshold to be an inventory product. The examples depicted in FIG. 10B are respective captures of the inventory products being held by customers 1010A, 1020A in FIG. 10A. In the illustrated embodiments, the bottom image 1015B depicts a series of images that show the frictionless shopping system tracking the inventory product 1015A by the first customer 1010A. Likewise, the top image 1025B depicts a series of images that show the frictionless shopping system tracking the inventory product 1025A by the second customer 1020A.

The images depicted in FIG. 10B should be understood to be selections the frictionless shopping system has made from the full image of the entire shopping area. Image processing techniques may be utilized along with various machine learning, predetermined rule sets, and/or deep convolutional neural networks to make decisions on which area of the image to focus on and analyze. The selection of an area of a larger image may then be passed to other logic that may further determine including, but not limited to, inventory product SKU, which hand the inventory product is being held in, length of time held, where the customer puts the inventory product down, whether the product is an age restricted product, and/or whether the customer, who grabbed the age restricted product, is associated with a facial wallet with an age verification that may be used to purchase the age restricted product. It should be understood that such techniques may also be helpful for store inventory loss tracking.

Information as shown and described in detail herein is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail may be made, without departing from the spirit and scope of the present disclosure, as set forth in the appended claims, as might be apparent to those of ordinary skill in the art, are also encompassed by the present disclosure.

What is claimed is:

1. A frictionless shopping system, comprising:
one or more intelligent shelving units configured with:
one or more cameras; and
one or more audio sensors;
wherein at least one of the one or more intelligent shelving units includes an area with restricted access;
one or more processors communicatively coupled to the one or more shelving units; and
a frictionless shopping logic configured to direct the one or more processors to:
receive a plurality of images captured with the one or more cameras;
receive one or more audio signals captured with the one or more audio sensors;
identify, via a facial recognition logic, a customer within a shopping area, wherein the facial recognition logic utilizes at least one of the plurality of images and the one or more audio signals;
match, via a customer matching logic, the identified customer with customer account data associated with the identified customer; and
generate facial wallet with at least an associated age verification linked with the matched customer.

2. The frictionless shopping system of claim 1, further comprising an enrollment server, wherein the frictionless shopping logic can communicate with the enrollment server to perform an age verification on the matched customer.

3. The frictionless shopping system of claim 2, wherein the age verification can be performed through a mobile shopping application.

4. The frictionless shopping system of claim 3, wherein the mobile shopping application can be configured to capture images of the matched customer's identification card.

5. The frictionless shopping system of claim 4, wherein the mobile shopping application can utilize one or more authentication processes to verify the matched customer's identification card is valid and the customer is older than one or more predetermined age thresholds.

6. The frictionless shopping system of claim 5, wherein the authentication process is performed by a human through a review of the captured images.

7. The frictionless shopping system of claim 5, wherein the authentication process is performed by one or more image recognition processes.

8. The frictionless shopping system of claim 6, wherein the facial wallet is updated to include the verified age of the matched customer.

9. The frictionless shopping system of claim 8, wherein the frictionless shopping logic is further configured to permit one or more frictionless shopping features in response to a validation of the matched customer's age exceeding one or more predetermined age thresholds.

10. The frictionless shopping system of claim 9, wherein the one or more frictionless shopping features include permitting access to at least one of the one or more intelligent shelving units with a restricted access area.

11. The frictionless shopping system of claim 10, wherein the restricted access area includes alcoholic products.

12. The frictionless shopping system of claim 10, wherein the restricted access area includes theft-susceptible products.

13. The frictionless shopping system of claim 10, wherein the restricted access area includes pharmaceutical products.

14. A frictionless shopping system, comprising:
one or more intelligent shelving units configured with:
one or more cameras; and
wherein at least one of the one or more intelligent shelving units includes an area with restricted access;
one or more processors communicatively coupled to the one or more shelving units; and
a frictionless shopping logic configured to direct the one or more processors to:
receive a plurality of images captured with the one or more cameras;
identify, via a facial recognition logic, a customer within a shopping area, wherein the facial recognition logic utilizes at least one of the plurality of images;
match, via a customer matching logic, the identified customer with customer account data associated with the identified customer;
access a facial wallet with an associated pre-verified age linked with the matched customer; and
permit access to a restricted access area in response to the matched customer's pre-verified age exceeding one or more predetermined age thresholds.

15. The frictionless shopping system of claim 14, wherein, upon accessing the matched customer's pre-verified age, the granting of access to a restricted access area occurs for a predetermined period of time.

16. The frictionless shopping system of claim 14, wherein, upon accessing the matched customer's pre-verified age, the granting of access to a restricted access area occurs within a certain distance of the matched customer within the shopping area.

17. The frictionless shopping system of claim 14, wherein, upon accessing the matched customer's pre-verified age, the granting of access to a restricted access area occurs until at least one age-restricted product is selected by the matched customer.

18. The frictionless shopping system of claim 17, wherein age-restricted product selected by the matched customer is tracked until the product is returned to the original restricted access area or is purchased by the matched customer.

19. The frictionless shopping system of claim 14, wherein the matched customer is notified about the selected age-restricted product in response to the age-restricted product not being returned to the original restricted access area.

20. The frictionless shopping system of claim 14, wherein the matched customer is notified about the selected age-restricted product in response to the age-restricted product being given to another matched customer that does not have a pre-verified age above a similar pre-determined age threshold within the frictionless shopping system.

21. A method of selling age-restricted products in a frictionless shopping environment, comprising:
receiving a plurality of images captured with one or more cameras disposed on a plurality of intelligent shelving units;
identifying, via a facial recognition logic, a customer within a shopping area, wherein the facial recognition logic utilizes at least one of the plurality of images;
matching, via a customer matching logic, the identified customer with customer account data associated with the identified customer;
accessing a facial wallet with an associated pre-verified age linked with the matched customer; and
permitting, in response to the matched customer's pre-verified age exceeding a predetermined age threshold, access to a restricted access area within one or more intelligent shelving units configured with a restricted access area.
